(19) United States
(12) Patent Application Publication
(10) Pub. No.: US 2025/0169404 A1
(43) Pub. Date: May 29, 2025

(54) PLANTER SYSTEM ENHANCING GROWTH, CARE, MAINTENANCE, AND DISPLAY OF CONTAINER PLANTS

(71) Applicant: KEVIN FITZGERALD JOHNSON, SPENCER, VA (US)

(72) Inventor: KEVIN FITZGERALD JOHNSON, SPENCER, VA (US)

(21) Appl. No.: 19/036,942

(22) Filed: Jan. 24, 2025

Related U.S. Application Data
(63) Continuation-in-part of application No. 18/212,539, filed on Jun. 21, 2023, now abandoned.
(60) Provisional application No. 63/354,140, filed on Jun. 21, 2022.

(51) Int. Cl. A01G 9/02; A01G 9/029; A01G 9/12; A01G 9/14; A01G 27/00; A01G 27/06; A01G 31/02; A01K 63/00; C05F 17/05

(52) U.S. Cl. CPC A01G 9/0302; A01G 9/023; A01G 9/024; A01G 9/028; A01G 9/029; A01G 9/12; A01G 27/005; A01G 27/008; A01G 27/06; A01G 31/024; A01K 63/00; C05F 17/05; A01G 9/1438

(57) ABSTRACT

A multifunctional accessory based planter system that uses various appliances and accessory combinations to alter the purpose based upon a desired goal. Primarily, the planter system consists of a base container with upper and lower attachment points/ports and a handled platform/transplanter insert. Additionally, numerous supplementary accessories attach to and fit in the base container that modify the functionality of the base container from plant care and maintenance, plant propagation, transplanting, composting, and display.

### CROSS-REFERENCE TO RELATED APPLICATION

This application is a continuation-in-part of U.S. patent application Ser. No. 18/212,539,filed Jun. 21, 2023, which application claims the benefit of U.S. Provisional Patent Application No. 63/354,140, filed on Jun. 21, 2022, the contents of each of which are hereby incorporated by reference in their entirety.

### BACKGROUND

### 1. Field

The present disclosure relates to planter systems, and particularly to planter systems with watering and aeriation.

### 2. Description of the Related Art

Discerning accurate information about a potted plant's health status and environmental conditions is challenging. It is essential to have accurate information in order to make the appropriate adjustments so that the container plants can survive and thrive. Container plants exist in a restricted, artificial environment where they typically attempt to endure in less than ideal circumstances because of improper and inefficient watering, inefficient and inconsistent feeding, and insufficient aeration. Most container plant enthusiasts, unfortunately, do not have the knowledge, time, patience or understanding of how to create an ideal growing environment for container plants that will allow the plants to thrive. The container plants are not able to develop naturally or to independently create their ideal growing conditions because of the limited environment and improper care.

Also, container plants must also endure traumatic processes when transplanting becomes necessary. Container plants are often traumatized by the rough nature of the universally accepted transplanting process that requires banging the host pot against a hard surface repeatedly and then grasping the plant and pulling it out of the pot. This method typically shocks, damages, or kills the transplanted plant.

Container plants, from aesthetic and efficiency standpoints, are routinely and traditionally displayed in bland container/saucer pairings that are neither visually appealing nor efficient from a survival standpoint. The presentation of container plants is very limited due to the relatively few options available.

Prior art approaches still fail to address a majority of the problems discussed above. For instance, WO 2005/015981 A1 to Buttendag moves/replaces a pot from a container to another exact same sized container. This is not the traditional definition of transplanting because the plant still remains in its original host container. Typically, transplanting is defined as moving just the plant, roots and soil without the container to a new location. Because the Buttendag platform does not have any sides or is fully encircled, it does not have/provide a means of freeing/denesting/removing a plant and soil from its host pot in order to transplant into a larger container.

Additionally, the Buttendag patent has a water reservoir that fully encircles the plant and rises to the top of the container. This cumbersome approach requires a threaded plug to be removed when filling the reservoir and then coordinating the water flow via a valve seal that creates a vacuum. Also, the center tube in Buttendag's patent is actually a water overflow exit that is a separate piece from the platform. However, there is no mechanism by which the water is returned from the reservoir into the container plant's root area.

Another major difference in the Buttendag patent is the design of the platform which has numerous holes/apertures in its platform that allow water to rise into the soil from the bottom reservoir. Buttendag requires an upper surface of its support tray to be treated with an appropriate chemical such as for example trifluralin which is sold under the trade name BIOGUARD ROOT CONTROL FABRIC™ to repel plant roots 74 of plants 76 planted in the unit 10″. Even with the fabric, plant roots will inevitably over time make their way (grow) through the fabric and intertwine/entangle with the support platform thus extracting the plant from the container very difficult and damaging to the plant. The Buttendag design does not provide a provision to inject air into the soil from the sides.

KR 20080107742 to Lee discloses a platform design that has numerous holes/apertures in its platform that allow water to rise into the soil from the bottom reservoir. This approach allows the plant roots to become completely intertwined/entangled in the platform. Lee's platform design has a hole in the side of the container that allows a rotating drain to attach to the container. It has a lock nut on the inside that attaches to a hollow through bolt. When tightened, the hollow through bolt creates a watertight seal. A rotating 90° elbow joint attaches to the through bolt. Finally, a transparent cylinder is placed in the 90° elbow joint. This rotating attachment configuration is quite common. The elbow joint in Lee's design is not transparent so the amount of water in the container is not known until it reaches the level of the attached transparent tube. The Lee patent requires that the contents need to be removed before disconnecting the lock nut. Finally, the Lee patent does not have a provision for letting air into the soil and root system from the sides.

US 2002/0088177 to Gergek discloses a two container nested system where water is pumped into the bottom cavity created between the containers. The water enters through a tube at the top of the container and is then pumped to the bottom and finally forced up into the plant root area. The excess water is then allowed to drain back into the bottom where it is then pumped back out.

Present container plant systems do not allow a user to easily acquire accurate information about a plant's health status (root-bound, proper root system, etc.) and/or environmental conditions (hydration, aeration, etc.) or easily adjust, as necessary. Thus, a planter system with watering and aeriation solving the aforementioned problems is desired.

### SUMMARY

There is a need for an innovative, multifunctional, component planter system that assists in creating ideal independent growing environments for container plants that allows plants to survive. It is further beneficial for the planter system to provide a mechanism for plants to be easily moved to different pots with unlimited design options to change the presentation. The innovative, multifunctional, component planter system provides a means:
to monitor and properly adjust water levels as necessary for a container plant based on the plant's individual preferences.
to increase soil aeration in container plants
to easily relocate plants to different pots with unlimited design options to change the presentation
to lessen trauma during transplanting
to increase container portability
to eliminate saucer type bottom supplementary overflow spill trays
to reduce overflow spills when watering a plant directly from the top
to examine a plant's root system via nontraumatic and/or non-stressful methods
to replace a container's nutrient depleted soil via nontraumatic means
to hydroponically grow and display plants
to germinate and nurse young plants
to recycle and convert trimmed or dead leaves into nutritious compost
to ship container plants more efficiently, more safely, and less traumatically
to create a terrarium
to support and/or display vining or ‘running’ plants
to support and/or display fruit laden plants
to support plants that are planted in hanging containers
to allow the soil to be used as part of the display
to allow water to be included as a part of the display (therapeutic dripping or passive observation of absorption rate)
to allow the handled platform/transplanter insert to be used as part of the container plant's display
to germinate a plant in soil using the base container with a dome. to use the base container as a grower pot with entering the bottom via the open ports
to ship by sealing the bottom attachment ports and adding the protective shipping attachments to remove shipping attachments after reaching destination and place the base container in an interlocking decorative planter, and then replace a seal of the base container with a rotating display for final display
to transplant less traumatically a container plant to a larger container using the handled platform/transplanter insert after the plant matures

A planter system, in one embodiment, includes a base container and a water evacuation tube located at a bottom portion of the base container. The water evacuation tube is movable from a position pointing up holding water in the base container and a position pointing down to drain water from the base container. A handled platform/transplanter insert is located in the base container and has a hole located at a bottom portion of the handled platform/transplanter insert. A feeding/watering/aeration tube extends through the handled platform/transplanter insert and through the hole into the base container. The planter system does not have a circular wall formation encircling the platform and does not use a vacuum to move water but utilizes a uses a vertical conduit wicking system. The planter system makes visual inspections of the plant's root system and water levels easy. The planter system makes visual inspections of the plant's root system and water levels easy encourages the use of a transparent container (different embodiments) and has upper and lower connection points, The water evacuation tube, in some embodiments, is transparent.

The base container, in other embodiments, is transparent allowing for accurate viewing and monitoring of roots.

The planter system can further include an outer container having a slot that accommodates the transparent water evacuation tube when the base container is located in the outer container; and an outer container gate that slides into the slot down to the transparent water evacuation tube to form a completely enclosed outer container perimeter.

The platform/transplanter insert can also include legs extending downward from the bottom portion of the insert leaving space between the bottom portion of the insert and the base container.

The handled platform/transplanter insert, in other embodiments, includes one or more wicking tubes extending into the base container creating a conduit for water to flow or wick from the base container into the handled platform/transplanter insert. One of the wicking tubes can be a center tube which is formed as part of the platform. Additional legs are used for balance/support after the handled platform/transplanter insert is removed and placed on a flat surface.

The handled platform/transplanter insert can further include arcuate handles for lifting the insert. A plant is easily transplanted using the handles.

In an additional embodiment the handled platform/transplant insert can include handles which are shaped with a isoceles trapezoid contour on three sides where the fourth side of the of isoceles trapezoid is open along the longer dimensioned base. In this additional embodiment, the handles are extended and foldable handles from a platform that will lift a plant out of its host container and then provide full access to a plant. This approach significantly reduces plant trauma and potential transplant shock. This additional embodiment also allows the user to simply pour water into the water reservoir behind the handles without having to calibrate the various features associated with the creation of a vacuum.

In this additional embodiment, the extendable and foldable handles can also have serrated edges around the handled platform's perimeter that allow excess water to drain from the root area into the bottom reservoir. Water is wicked from the reservoir into the root area via a centralized pipe that is packed with soil. The centralized pipe is part of the handled platform. The centralized pipe has slits in it that allow water to soak into the packed soil before being conducted into the root area.

Also, because the platform/transplanter insert design has handles of the additional embodiment instead of a fully encircled wall, one can visually inspect the plant roots and overall plant health when located in a transparent container. Additionally, the plant roots and soil will mold to the shape of the container and can be easily lifted and removed. Stickers or other decorations can be used to decorate the containers but still show the soil and roots located in the container. Therefore, when using a non-transparent container, the plant can be removed using the handles of the platform. Plant roots can be inspected and/or trimmed if necessary and then returned to its container, another container or transplanted to a larger container. The platform handles of the additional embodiment can further have serrations along the edges that allow air into the soil root area from the sides. These serrated edges around the handled platform's perimeter allow excess water to drain from the root area into the bottom reservoir. Or water can be poured into the reservoir behind the platform handles. Water is wicked from the reservoir via a centralized pipe(s) that is a part of the platform that is packed with soil. The centralized pipe has slits in it that allow water to soak into the packed soil before being moved into the root area.

A ledge as shown in FIGS. 14B and particularly in FIG. 24 is a defining feature of the handled platform/transplanter insert has a ledge 2419 near the top middle rear of the handle. As configured, the ledge allows water to flow around it when sending water down towards the reservoir and serves as a barrier to keep larger, unwanted items from accidentally reaching the reservoir. Primarily, the ledge is available to assist as warranted to assist as warranted with lifting/removing the handled platform/transplanter insert from the base container. A user's fingers can easily access the ledge especially when the handled platform/transplanter insert is properly in front of the sloped handle of the base container as shown in FIG. 20.

The ledge as shown in FIGS. 14B and particularly in FIG. 24 of the handled platform/transplanter insert has a slanted rear ledge 2421 which serves as an open space for water to flow into the reservoir when water is poured into the plant's soil too fast for it to be absorbed. The slanted rear ledge 2421 works in conjunction with the base container' inscribed line and reduces the chances of an overfilling situation. The inscribed line on the inside of the base container should be a short distance from the top of the base container. The inscribed line should match the bottom of the slant associated with the top rear of the handled platform/transplanter insert and when the handles press against the base container's sides, a space is created for water to enter the handles.

The handled platform/transplanter insert can also include two or more vermiculture containers each having matching holes allowing worms to move back and forth.

The handled platform/transplanter insert can additionally include two or more mini containers each having holes on a bottom portion allowing water to enter and drain

The planter system can further include a dome covering the handled platform/transplanter insert to control humidity and aid in plant germination.

A planter system, in an alternate embodiment, includes: a base container; a water evacuation tube located at a bottom portion of the base container, the water evacuation tube movable from a position pointing up holding water in the base container and a position pointing down to drain water from the base container; and a handled platform insert located in the base container providing a space between the bottom of the base container and the platform insert.

A grower cage can be attached to the platform insert at the upper attachment points.

The planter insert can further include multiple slots.

One or more grower pots can be located in one or more of the multiple slots.

One or more grower containers can be located in one or more of the multiple slots.

One or more breakaway containers can be located in one or more of the multiple slots.

The planter system can further include a dome covering the platform insert to control humidity and aid in plant germination.

These and other features of the present subject matter will become readily apparent upon further review of the following specification.

### BRIEF DESCRIPTION OF THE DRAWINGS

FIG. 1 is an illustration of a planter system.

FIGS. 2A, 2B and 2C are illustrations of the outer container having a slot and a gate that slides into the slot.

FIG. 2D is an illustration of the outer container having an opening for a water evacuation tube.

FIG. 3 is an illustration of the base container with a water evacuation tube.

FIG. 4 is an illustration of the platform/transplanter insert.

FIG. 5 is an illustration of the platform/transplanter insert with handles.

FIGS. 6A and 6B are illustrations of the vermiculture containers with the base container.

FIGS. 6C and 6D are a top view of multiple mini containers.

FIG. 6E is a front view of multiple mini containers.

FIG. 7 is an illustration of the base container with a dome.

FIG. 8A is an illustration of a platform having a rotating spout.

FIG. 8B is an illustration of a platform insert.

FIG. 8C is a side/front view of the platform insert.

FIGS. 9A and 9B illustrate a platform/cage combo.

FIG. 10A is an illustration greenhouse using a dome (not shown) of FIG. 7.

FIG. 10B is an illustration of a single grower pot placed on an insert in a base container and having a dome (not shown) of FIG. 7.

FIG. 10C is an illustration of multiple individual grower pots each having a dome.

FIG. 11A is an illustration of an individual grower container.

FIG. 11B is an illustration of a grower container filled with soil and a plant.

FIG. 11C is an illustration of an insert with openings for holding multiple grower containers.

FIG. 11D is an illustration of the insert with multiple grower containers placed inside the base container and a dome covering the base container.

FIG. 12A is an illustration of a slotted insert with multiple openings that hold open ended breakaway containers.

FIG. 12B is an illustration of the slotted insert placed inside a base container filled with water.

FIG. 13A is an illustration of a slotted insert with multiple openings that hold immature plants.

FIG. 13B is an illustration of the slotted insert placed inside a base container filled with water.

FIGS. 14A, 14B, 14C, 14D, 14E, 14F, and 14G are illustrations the handled platform/transplanter insert for use with the plant system including an alternative embodiment of the handles.

FIG. 15 is an illustration of the planter system with the three primary components all connected and interlocked.

FIGS. 16A, 16B, 16C, 16D, 16E, 16F, and 16G are additional illustrations the

handled platform/transplanter insert for use with the plant system including an alternative embodiment of the handles as discussed with regards to FIGS. 14A, 14B, 14C, 14D, 14E, 14F, and 14G.

FIGS. 17A, 17B, 17C, 17D, 17E, are illustrations inner container of the plant system.

FIGS. 18A, 18B are detailed top down views of two slotted platforms of FIGS. 12A-12B and 13A-13B, respectively, that sit across the tops the base containers to the plant system.

FIG. 19 is an alternative embodiment of the outer container of FIG. 2D which having multiple openings for water evacuation tubes.

FIG. 20 is a top down view of the handled platform/transplanter insert for use with the plant system including an alternative embodiment of the handles of FIGS. 16A, 16B, 16C, 16D, 16E, 16F, and 16G.

FIG. 21 shows a view of the handled platform/transplanter insert inside a base container.

FIG. 22 shows a view of the handled platform/transplanter being removed from the base container of FIG. 21.

FIG. 23 shows a view of the handled platform/transplanter being removed from the base container of FIG. 21 where the handles are away 90 degrees such that in this configuration total access to the soil and plant is obtained without obstruction.

FIG. 24 is a view of the handled platform/transplanter insert for use with the plant system including an alternative embodiment of the handles of FIGS. 14A, 14B, 14C, 14D, 14E, 14F, and 14G.

FIG. 25 shows a detailed view of the platform corresponding to the handled platform/transplanter insert.

FIG. 26 shows a partial profile of the platform corresponding to the handled platform/transplanter insert that highlights the serrations that allow water to seep into the reservoir from the top and that also allow air into the plant's soil from the bottom.

FIG. 27 shows a variable length hose for use with the plant system of FIG. 1.

FIG. 28 shows attachable rotating gauge/evacuation tube/spouts of variable length hose for use with the plant system of FIG. 1.

FIG. 29 shows a humidity dome accessory, shipping top accessory, or vermiculture top accessory as attached to a base container.

FIG. 30 shows a decorative outer container.

FIG. 31 shows a plant protector shipping top accessory.

FIG. 32 shows a recessed screw plug accessory that is used to plug an elongated hole tunnel (base container lower attachment point/port) from the outside.

FIG. 33 shows an illustration of the vermiculture containers with matching holes

FIG. 34 shows an illustration of the vermiculture container accessories with the base container resting on a handled platfor/transplanter insert.

FIG. 35 is an illustration of the base container with vermiculture container accessories as covered with a dome accessory attached to the base container using the upper attachment points.

FIG. 36 shows a top view of multiple mini container accessories when seperated from each other.

FIG. 37 shows a top view of multiple mini container accessories in a compact arrangment that would fit into a base container.

FIG. 38 is a front view of multiple mini container accessories.

FIG. 39 is a detailed top down view of two slotted hydroponic rack accessories of FIGS. 12A-12B and 13A-13B, respectively, that attach to the upper attachment points of the base container.

FIG. 40 is an illustration of the use of the base container as a centralized water distributor in a plant system where water poured into the central base container will flow to the attached base containers such that the water will equalize in all containers at the same level and where any base container with a rotating gauge/evacuation tube/spout can control the amount of water in the attached containers.

FIG. 41 is an illustration of a top down view of the use of the base container as a centralized water container distributor of FIG. 40.

FIG. 42 is an illustration of plurality of base containers set up in a series arrangement.

FIG. 43 is an illustration of plurality of base containers set up in a parallel

arrangement.

FIG. 44 shows a humidity dome, shipping top, or vermiculture top as attached to a decorative outer container in conjunction with a plant protector.

FIG. 45 shows a dome which can be used as cover a decorative outer container which is used to for plant transport.

FIG. 46 is a platform/transplanter insert with a transparent rotating gauge and evacuation tube.

Similar reference characters denote corresponding features consistently throughout the attached drawings.

### DETAILED DESCRIPTION OF THE PREFERRED EMBODIMENTS

There is a need for a planter system that enhances growth, irrigation, water conservation, feeding, aeriation, root inspection, presentation and transplanting. The planter system should create ideal independent growing environments for container plants that allows plants to survive and thrive. It is further beneficial for the planter system to provide a mechanism for plants to be easily moved to different pots with unlimited design options to change the presentation.

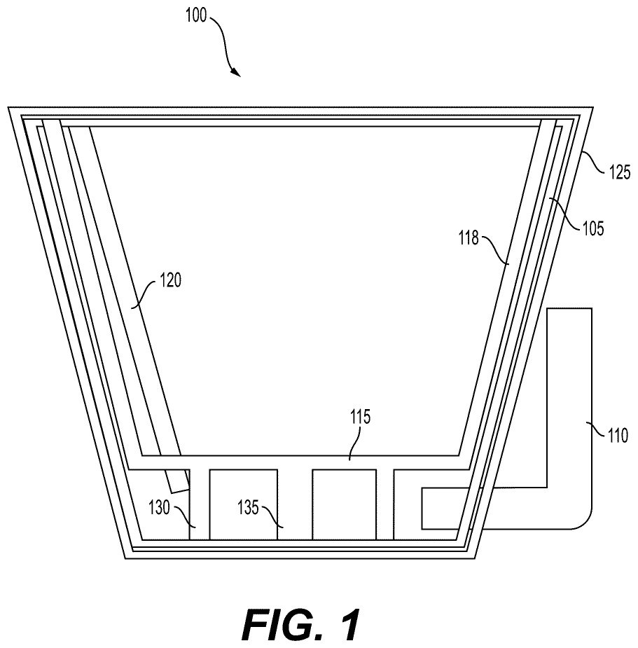

FIG. 1 is an illustration of a planter system 100 having watering and aeration mechanisms. A base container 105 includes a transparent water evacuation tube 110 located at a bottom portion of the base container. The transparent water evacuation tube 110 is movable from a position pointing up holding water in the base container 105, and a position pointing down to drain water from the base container 105. Intermediate positions are also possible. It serves as a water level gauge, water level set, and water inlet/outlet. The base container 105 also includes a through hole to accommodate the transparent water evacuation tube 110. The through hole, in some embodiments, is an elongated cylinder that adds stability and strength.

A platform/transplanter insert 115 is located in the base container 105. A feeding/watering/aeration tube 120 extends through the handled platform/transplanter insert 115 and through a hole at the bottom of the platform/transplanter insert 115 into the base container 105. The handled platform/transplanter insert 115 has handles 118 that allows the handled platform/transplanter insert 115 to be lifted making it easier to transplant a plant.

The base container 105 is transparent, in some embodiments, allowing for accurate viewing and monitoring of roots.

The planter system can further include an outer container 125 having a slot that accommodates the transparent water evacuation tube 110 when the base container 105 is located in the outer container 125. There is also an outer container gate that slides into the slot down to the transparent water evacuation tube 110 to form a completely enclosed outer container perimeter.

The handled platform/transplanter insert 115 can also include legs 130 extending downward from the bottom portion of the insert leaving space between the bottom portion of the handled platform/transplanter insert 115 and the base container 105.

The handled platform/transplanter insert 115 can also include one or more wicking tubes 135 extending into the base container 105 creating a conduit for water to flow from the base container 105 up through the handled platform/transplanter insert 115.

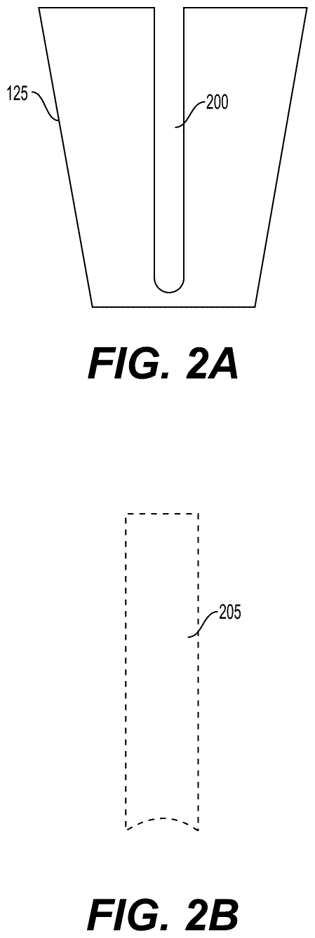

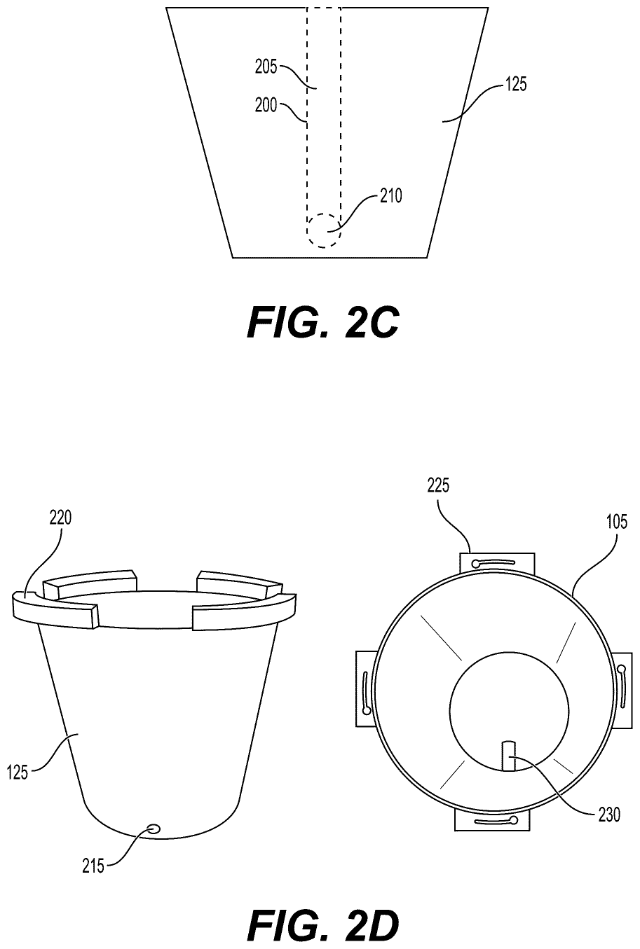

FIG. 2A is an illustration of the outer container 125 having a slot 200 that can accommodate the transparent water evacuation tube 110.

FIG. 2B is an illustration of a gate 205 that fits into the slot 200. The bottom part of the gate 205 allows the transparent water evacuation tube 110 to protrude from the outer container 125. The gate 205 slides into the slot 200 down to the transparent water evacuation tube 110 to form a completely enclosed outer container perimeter.

FIG. 2C is an illustration of the outer container 125 with the gate 205 positioned in the slot 200. A space 210 is provided for the transparent water evacuation tube 110 when the gate 205 is positioned within the slot 200. A completely enclosed water outer container perimeter is formed when the gate 205 is in the slot 200. Interlocking handles are included on both the base container 105 and the outer container 125. Both have component connection points. The base container 105 will nest inside the outer container 125. Also, the outer container 125 can have handles that seamlessly interlock with the base container. A rotating gauge can be inserted through the outer container into the base container.

FIG. 2D is an illustration of the outer container 125 having an opening 215. The transparent water evacuation tube 110 slides into the opening 215 negating the need for slot 200 and gate 205, as illustrated in FIGS. 2A to 2C. Outer container handles 220 interlock with base container handles 225. This allows for easy alignment of the opening 215 of the outer container 125 and elongated hole tunnel 230 of base container 105. The outer container 125 of FIG. 2D may also be used as a nursery pot by removing the water evacuation tube 110.

From an aesthetic standpoint, the outer container 125 of the planter system 100 can be made of any material and have any design or color scheme. The potential design, material, and color schemes and/or themes are truly unlimited. The containers are also interchangeable which allows a plant to be presented in a new or different container easily and without any trauma.

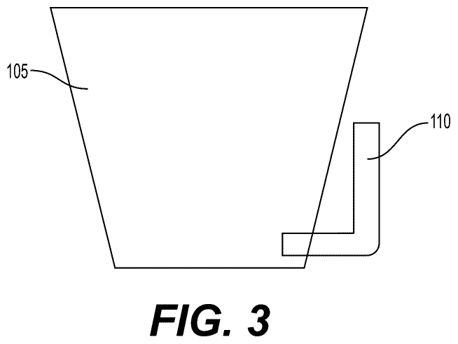

FIG. 3 is an illustration of the base container 105 with a transparent water evacuation tube 110 that rotates from a position pointing up (as illustrated) to a position pointing down. Water is held within the base container 105 when the transparent water evacuation tube 110 is in the position pointing up. Rotating the transparent water evacuation tube 110 to point downward will allow water to be drained from the base container 105. The base container 105 fits within the outer container 125 so that the transparent water evacuation tube 110 slides into the slot 200. The gate 205 slides into the slot 200 down to the transparent water evacuation tube 110 to form a completely enclosed outer container perimeter. The transparent water evacuation tube 110 can be made of two pieces. A first straight tubular piece has a first end that connects/slides horizontally into the base container 105, and a second raised connector end that extends outside of the base container 105. The second vertical piece is a straight tubular piece that connects vertically onto the first straight tubular piece via the second raised connector end. After connected, the requisite right angle is complete. The second vertical piece can vary in length dependent upon the intended use of the container.

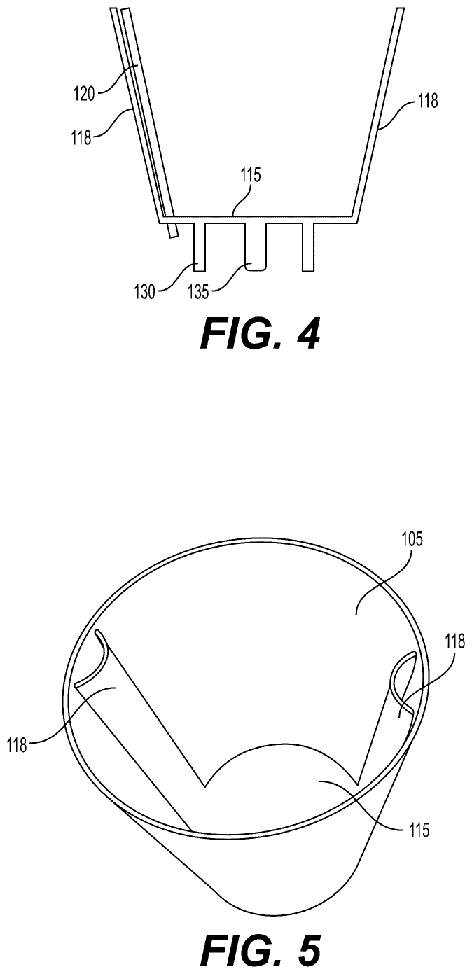

FIG. 4 is an illustration of the handled platform/transplanter insert 115 having legs 130 extending downward from the bottom portion of the handled platform/transplanter insert 115 leaving space between the bottom portion of the handled platform/transplanter insert 115 and the base container 105.

The handled platform/transplanter insert 115 also has one or more wicking tubes 135 extending into the base container 105 creating a conduit for water to flow from the base container 105 into the handled platform/transplanter insert 115. Multiple wicking tubes 135 can serve as legs, in some embodiments, making it unnecessary to include legs 130.

Handles 118 allow the handled platform/transplanter insert 115 to be lifted making it easier to transplant a plant. The handled platform/transplanter insert 115 allows the plant to sit on a flat surface after being removed from the base container 105. The handles 118 of the handled platform/transplanter insert 115 are designed to create a channel to let water and/or air flow to the bottom of the base container 105. The handles 118 are also designed to funnel water into the channel when watering volume threatens to overflow the top area when pouring too quickly directly on the plant. After lifting and removing the handled platform/transplanter insert 115 from the base container 105, the platform handles 118 fold out of the way. The handled platform/transplanter can have periodic openings around its perimeter that allows water to slowly seep into the lower regions of the base container 105. Base container 105 has handles 118 and component connection points. The handles 118 can be three sided, having two outer segments and a middle segment. The middle segment has the ability to bend while the two outer segments are shorter and do not fully extend to the top or bottom of the base container 105. The design of handles 118 can negate the need for feeding/watering/aeration tube 120.

The innovative planter system 100 as described assists in creating ideal independent growing environments for container plants that allow plants to survive and thrive. Additionally, plants can be easily moved to different pots with unlimited design options to change the presentation.

When watering, the transparent water evacuation tube 110 located on the outside of the container allows the user to monitor the water level as a plant is being watered or as the plant absorbs the water. A user can visually see the water level rise or fall in real time depending on what action is taking place. The tube has the ability to rotate which allows user to remove any excess water if plant is accidentally overwatered or intentionally saturated. Also, water efficiency and conservation are increased because water can be extracted from the reservoir via the rotating tube and used to re-water the plant if necessary or desired. Also, the rotating tube prevents spills when overwatering. Typical plant container saucers fill then overflow immediately after capacity is reached. Additionally, the innovative planter system 100 conserves water because less evaporation takes place than in traditional planters. The water reservoir is exposed to air only via the evacuation tube and the feeding/direct watering/aeration tube 120. The configuration reduces the open surface for water to evaporate. The sum of the area of the two access points is significantly less than the sum total of the area from the circumference/perimeter of typical plant container saucers. Water often flows through the soil into the container saucer. Often the water evaporates into the atmosphere without the plant absorbing the water. In addition, most users will not water their plants when there is water stored in the saucer which often causes the soil to become too dry while waiting for the water to evaporate from the saucer.

The planter system, as disclosed, differs from what currently exists. A better and more effective/efficient container growing environment is created because of better access to real time and precise information regarding watering and feeding and better aeration because both the evacuation tube and the feeding/direct watering/aeration tube allow fresh, circulating air into the root area of the plant. The system allows air to mix with the water before the water is absorbed by the plant via the wicking tube(s)/transplant stand.

When transplanting, user simply grasps the handles and lifts, then removes the plant from the base container. This process is less traumatic for the plant, easier for the user, and less damaging to the container.

FIG. 5 is an illustration of the handled platform/transplanter insert 115 with handles 118 located within the base container 105. The handles 118, in this embodiment, are modified to have a curved, multi sided shape that creates a space between the handle and sidewall of the base container 105, and allows water and air to enter the bottom of the base container 105. The feeding/watering/aeration tube 120 is not necessary in this embodiment, but can be included.

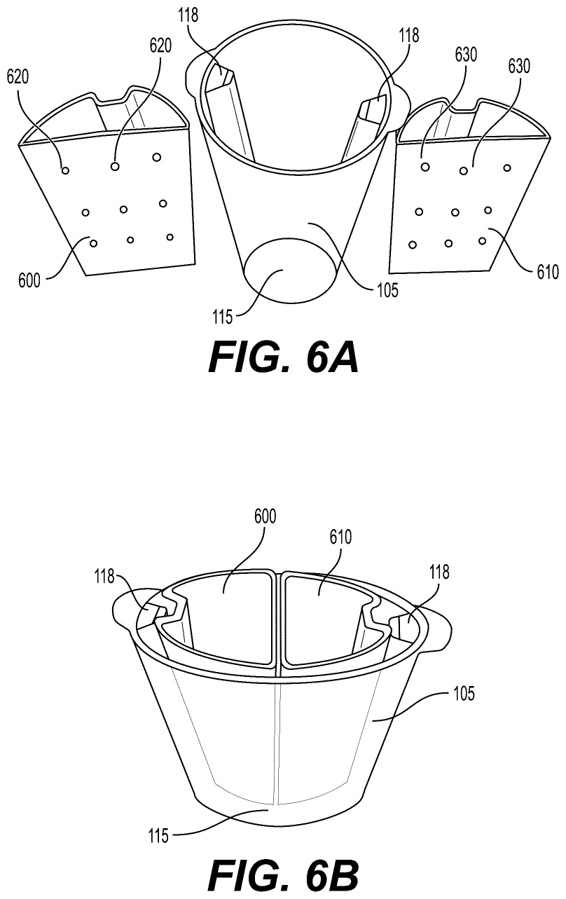

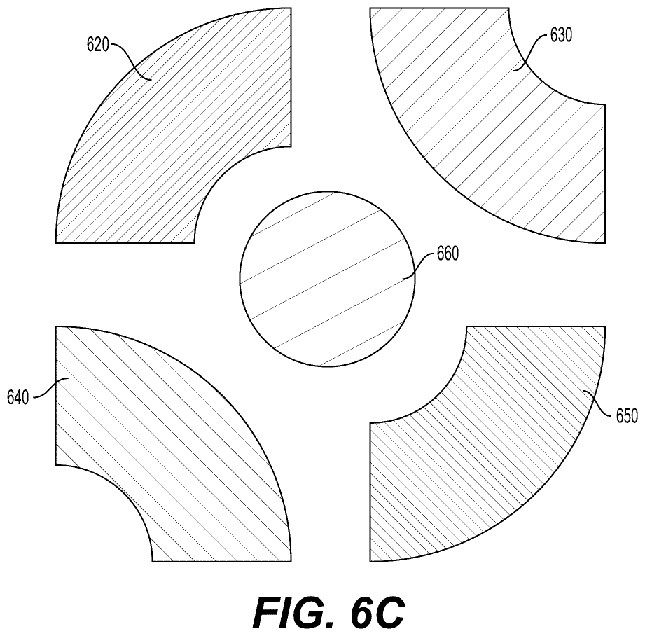

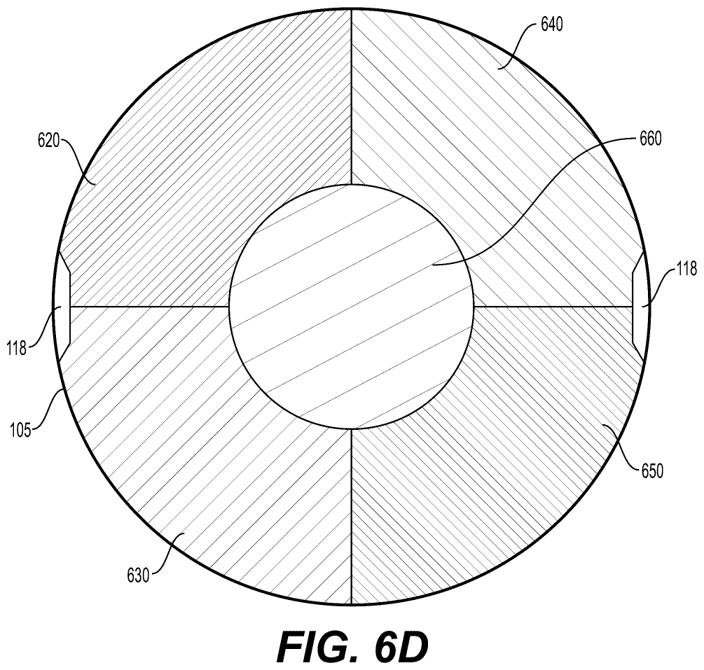

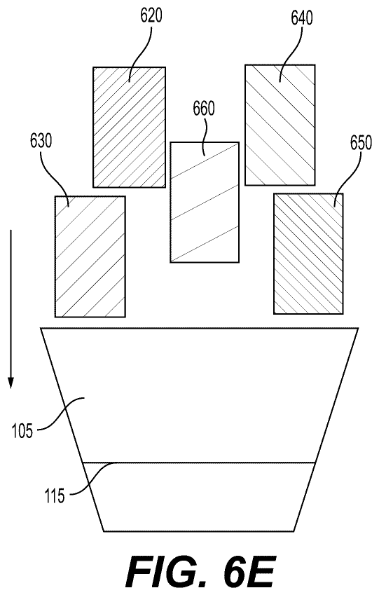

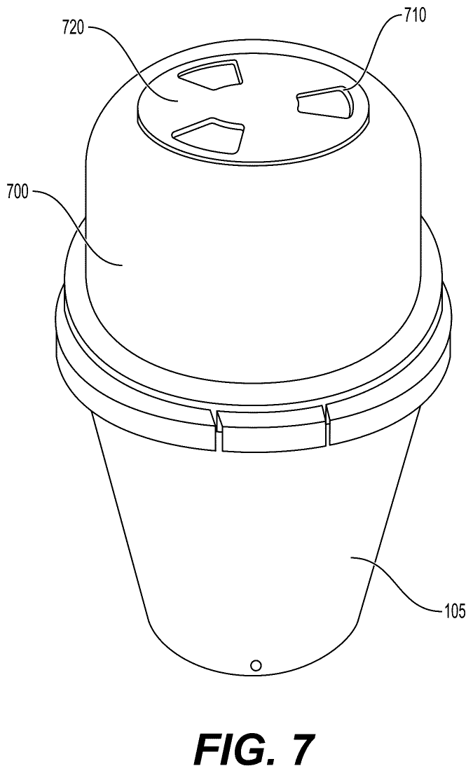

The handled platform/transplanter insert 115 can also include two or more vermiculture containers (600,610), as illustrated in FIG. 6A, each having matching holes (620,630) allowing worms to move back and forth. The vermiculture containers (600,610) fit within the base container 105 on top of handled platform/transporter insert 115 with the handles 118 pushed to sides against the base container 105. A slot (not shown) at the bottom of each vermiculture container allows for water to enter the vermiculture container. The vermiculture containers (600,610) encourage horizontal migration and easier castings extraction. A dome 700, as illustrated in FIG. 7, can be connected to the vermiculture containers (600,610), and can help contain the worms and allow easy access for watering and feeding.

FIG. 6B is an illustration of the vermiculture containers (600,610) located within the base container 105 on the handled platform/transplanter insert 115. Handles 118 are illustrated as protruding from the base container 105 and can be used to easily transplant a plant from the base container 105.

FIGS. 6C and 6D are a top view of multiple mini containers (620, 630, 640, 650, 660) and FIG. 6E is a front view. Each of the mini containers (620, 630, 640, 650, 660) vertically slides in and out individually and fits into the base container 105. They all rest on the platform/transplanter 115 and fit around the platform handles 118. The tops of each of the mini containers (620, 630, 640, 650, 660) are open but the sides are solid. The bottoms have numerous small openings to allow water to both enter and to drain from the container. The mini containers (620, 630, 640, 650, 660) can be used to host a variety of plants like dish gardens or used as a plant nursery. This configuration is one example and many variations are possible. For example, matching holes can be included in the sides of the mini containers (620, 630, 640, 650, 660) allowing worms to move back and forth; the mini containers (620, 630, 640, 650, 660) can be transparent to allow visual inspection of the roots; or the mini containers (620, 630, 640, 650, 660) can be of different sizes and shapes than those illustrated.

The base container 105, as illustrated in FIG. 7, can further include a dome 700 covering the handled platform/transplanter insert 115 (not shown) to control humidity and aid in plant germination. The dome 700 attaches to the base container 105 and includes adjustable access ports 710. Seed germination, watering access, feeding access, and worm containment will be improved by including dome 700. A rotating piece 720 that connects to the top of dome 700 can vary the size of the openings in the dome 700. The dome 700 connects to the container via the connection points. It can be made of clear/transparent materials.

The base container 105 fits snugly inside the outer container 125. A handled platform/transplanter insert 115 with legs 130 and one or more wicking tubes 135 fits snugly inside of the base container 105 (space around sides let water flow through soil into bottom into the reservoir). A transparent rotating water evacuation tube 110 is attached through a hole in the side near the bottom of the base container 105. The handled platform/transplanter 115 has a feeding/watering/aeration tube 120 attached to a hole in the handled platform/transplanter insert 115.

The base container 105, transparent rotating water evacuation tube 110, handled platform/transplanter insert 115, and feeding/watering/aeration tube 120 all work in conjunction to make the unit function properly. Additionally, rollers could be attached to the outer container 125 to make larger units easier to move.

The unit can function without the outer container 125. Users can visually assess the overall health of the plant by viewing the roots growing in the soil in the base container 105 if the base container 105 is transparent. The base container 105 can be decorated/adorned with stickers, slogans, images, etc. in order to personalize the appearance. FIG. 5 shows handles 118 on the platform/transplanter insert 105 as being hollow making the feeding/watering/aeration tube 120 unnecessary.

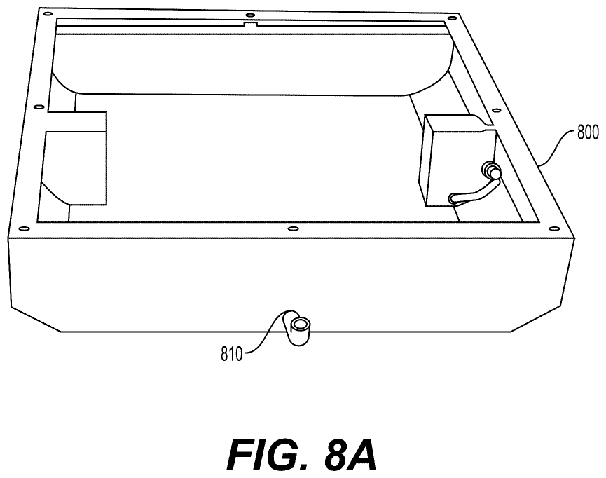

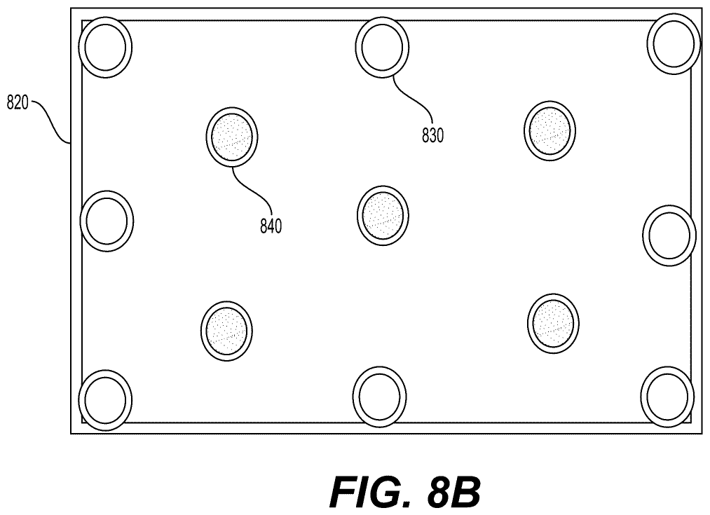

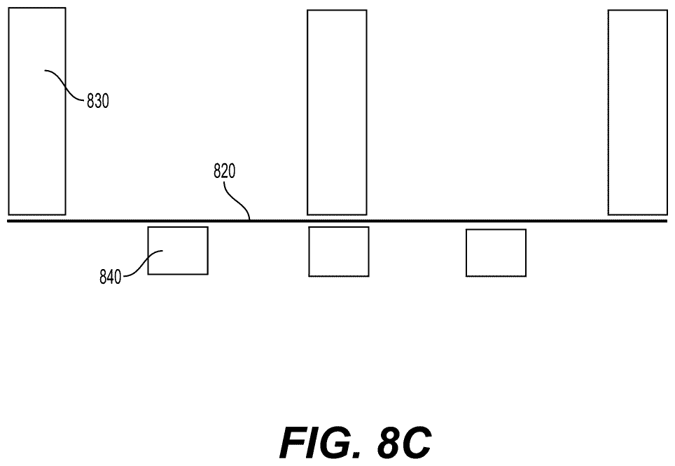

The unit, in an alternate embodiment, can be made large enough to accommodate landscape plants. FIG. 8A is an illustration of a platform 800 having a rotating spout 810. FIG. 8B is an illustration of a platform insert 820 that includes hollow watering tubes 830 and wicking channels/platform supports 840. FIG. 8C is a top view of platform insert 820. The platform insert 820 is placed in the platform 800. The platform 800 can accommodate different inserts, other than platform insert 820, that allow the functionality to change based on what components are used. For example, vermiculture containers (600,610), as illustrated in FIG. 6A, or multiple mini containers (620, 630, 640, 650, 660), as illustrated in FIGS. 6C to 6E, could be implemented as a type of insert for platform 800. The variations are endless.

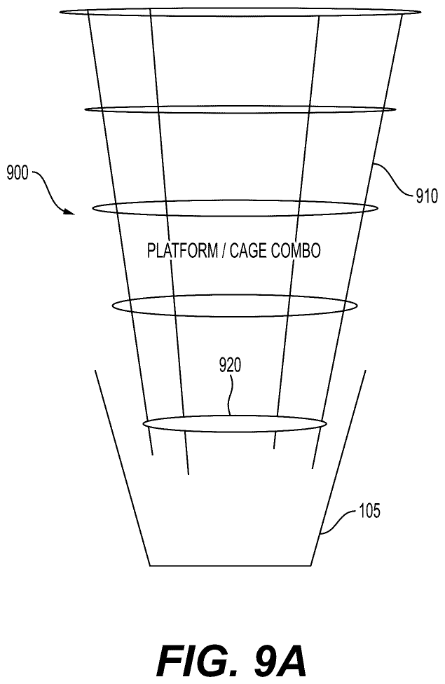

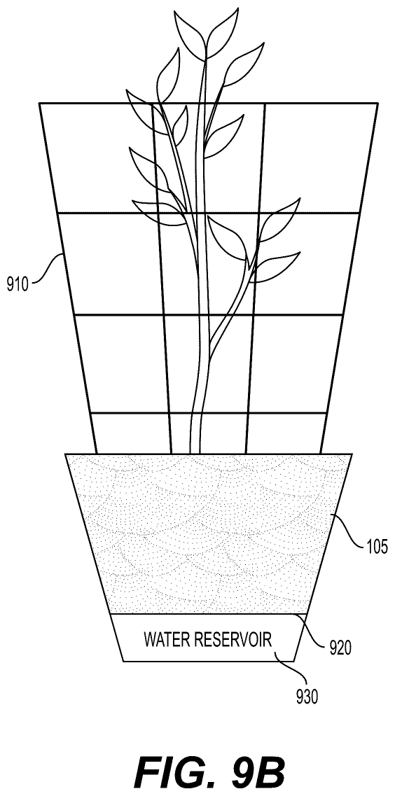

FIGS. 9A and 9B illustrate a platform/cage combo 900 that fits within the base container 105 that includes a rotatable waterspout (not illustrated). A grower cage is 910 and is attached to a platform 920 forming the platform/cage combo 900. A water reservoir 930 is formed below the platform 920, and the grower cage 910 allows a plant to mature with support. The plant can be removed from the base container 105 by lifting the platform/cage combo 900. The platform/cage combo can be attached to the base container 105.

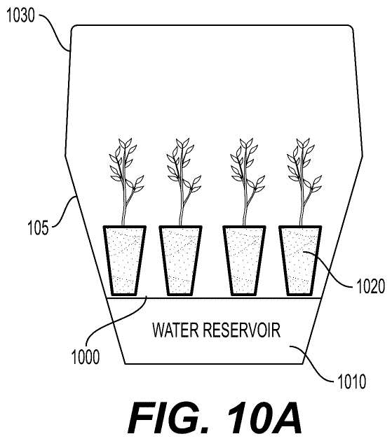

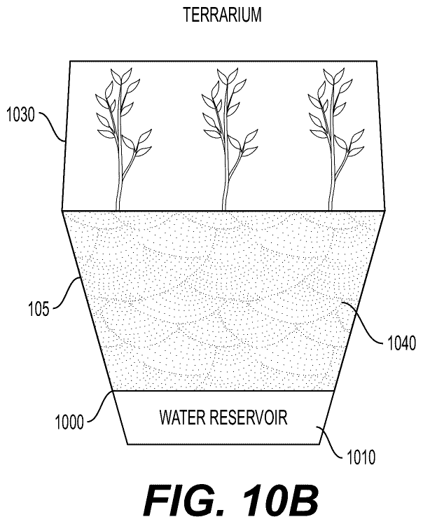

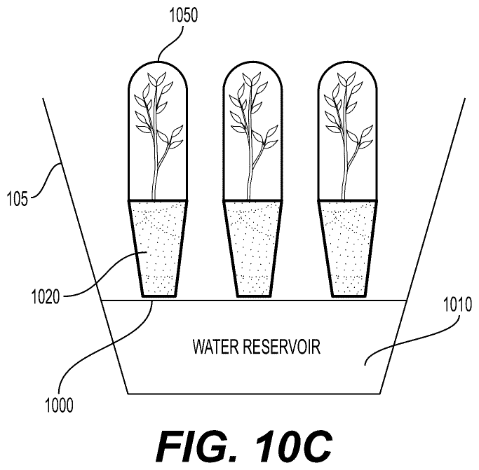

FIG. 10A is an illustration of a greenhouse using a dome. An insert 1000 is placed inside the base container 105 forming a water reservoir 1010. The base container includes a rotatable waterspout (not shown) to adjust the level of water in the reservoir 1010. Individual grower pots 1020 are placed on the insert 1000, and a dome 1030 is placed on the base container 105 covering the individual grower pots 1020. FIG. 10B is an illustration of a single grower pot 1040 placed on the insert 1000 in the base container 105, and having a dome 1030. FIG. 10C is an illustration of each of the individual grower pots 1010 having its own dome 1050.

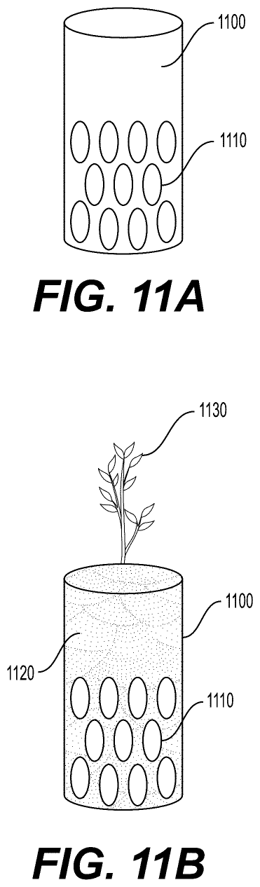

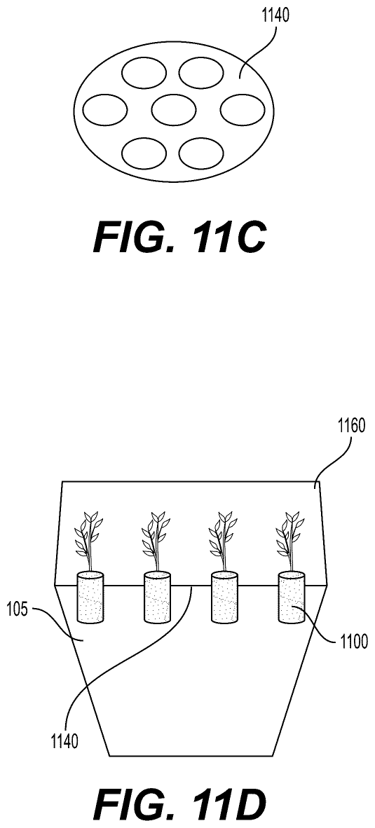

FIG. 11A is an illustration of an individual grower container 1100 having holes 1110 in around the bottom of the container. FIG. 11B is an illustration of the grower container 1100 filled with soil 1120 and a plant 1130. FIG. 11C is an illustration of an insert 1140 with openings 1150 for holding multiple containers 1100. FIG. 11D is an illustration of the insert 1140 with multiple grower containers 1100 placed inside the base container 105 and a dome 1160 covering the base container 105.

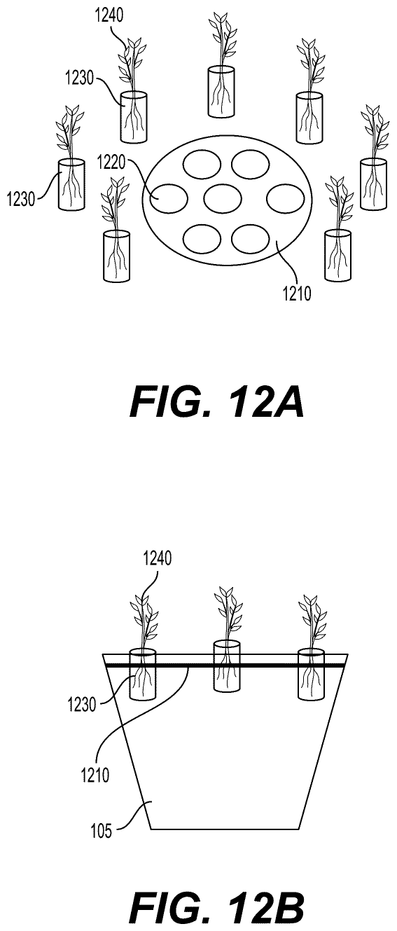

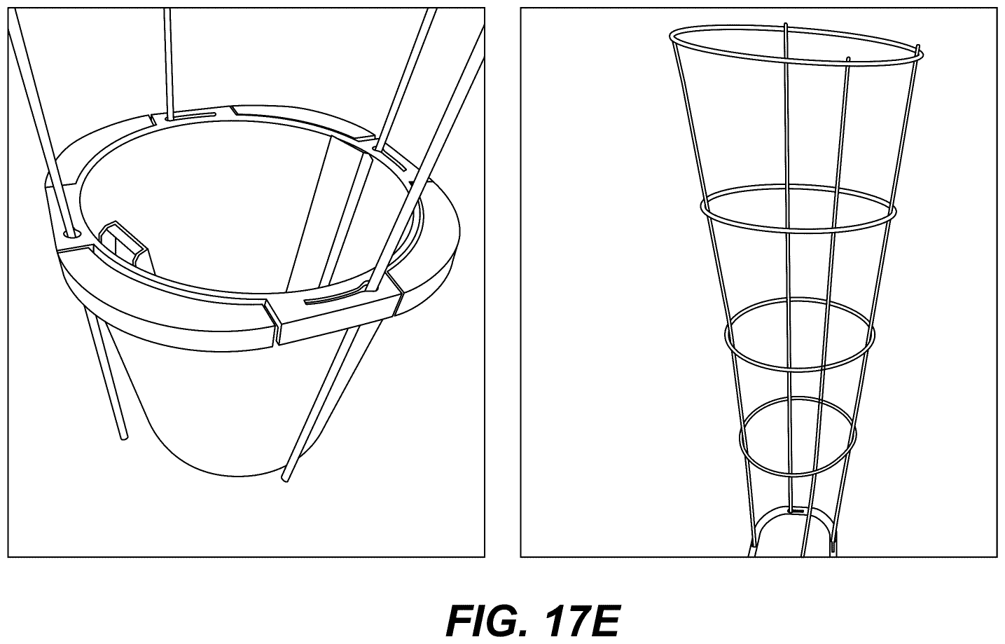

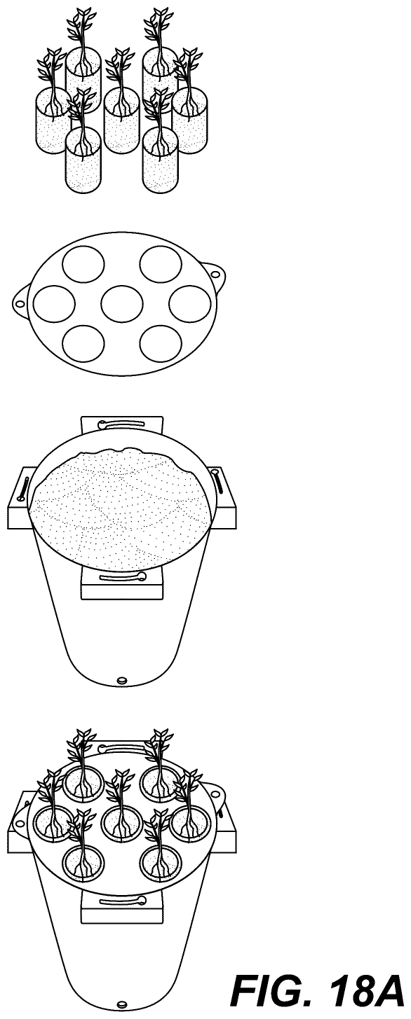

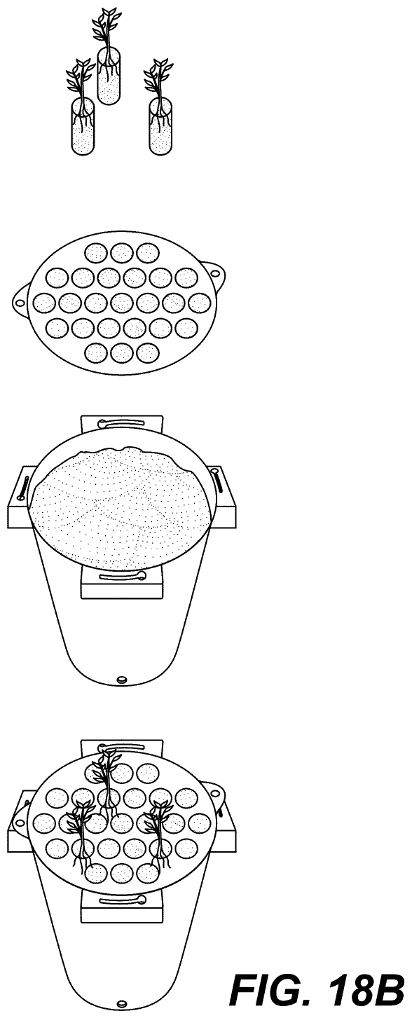

FIG. 12A is an illustration of a slotted insert 1210 with multiple openings 1220 that hold open-ended breakaway containers 1230. The open-ended breakaway containers 1230 hold immature plants 1240 until they are mature and ready for transplanting. FIG. 12B is an illustration of the slotted insert 1210 placed inside the base container 105 which is filled with water. The slotted insert 1210 can include interconnections along the perimeter to interlock with the outer container handles 220 or the base container handles 225. Alternately, the slotted insert 1210 can include pegs along the perimeter, which fit into holes in the outer container handles 220 or the base container handles 225. FIG. 18A is a top down view of the slotted insert of and base container of FIGS. 12A-12B.

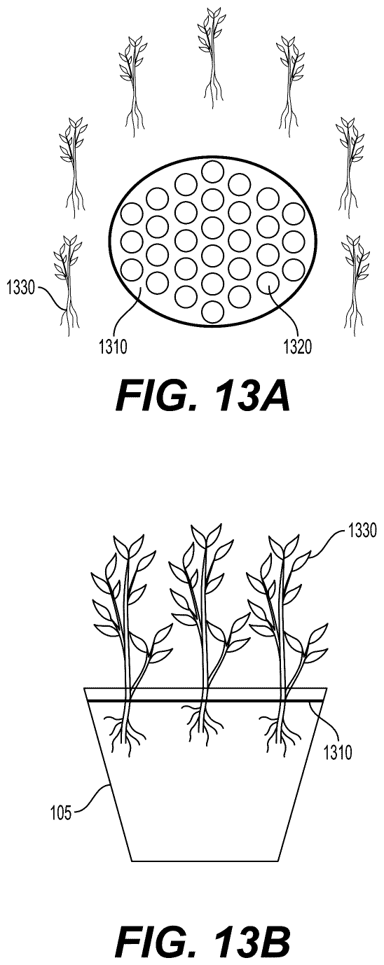

FIG. 13A is an illustration of a slotted insert 1310, with multiple openings 1320 that hold immature plants 1330 without individual containers. FIG. 13A is an illustration of the slotted insert 1310 placed inside the base container 105 which is filled with water. FIG. 18B is a top down view of the slotted insert of and base container of FIGS. 13A-13B.

The base containers 105, as described, can be used with the outer container 125. The outer container 125 and the outer container gate 205 can be joined to form a completely enclosed perimeter as illustrated in FIG. 2C. However, the area where the container and gate are joined leaves an opening 210 for the transparent rotating water evacuation tube 110 to protrude through the outer container 125.

Because the transparent rotating water evacuation tube 110 is connected to the base container 105 through a hole located near the bottom of the transparent base container 105, water can be removed via the opening in the tube from the container by gravity by simply rotating the tube. When the tube is upright, the water level in the base container 105 can be viewed in the transparent rotating water evacuation tube 110.

The feeding/watering/aeration tube 120 is attached to the platform/transplanter insert 115 through a hole in the bottom of the platform/transplanter insert 115.

The wicking tubes 135 that create the raised area of the platform should be packed with soil. The packed soil enhances the wicking effect by creating a conduit for the water to flow from the reservoir into the plant root area. The platform/transplanter insert 115 should be covered with a thin layer of soil. Then, the plant and soil media are placed on the platform/transplanter insert 115.

The base container 105 is inserted into outer container 125 by aligning the transparent rotating water evacuation tube 110 with the opening 210 in the side of outer container 125.

The handled platform/transplanter insert 115 is placed into the base container 105. Soil is then tightly packed around the platform legs 130. The handled platform/transplanter insert 115 is covered with soil. A plant is then placed in the base container 105 on the handled platform/transplanter insert 115. The remaining space is filled with soil which is moistened by adding water. The plant is watered and fed while monitoring the water level through the transparent rotating water evacuation tube 110. The transparent base container 105 allows users to visually inspect and monitor root development and the overall health of the plant. Users can accurately and precisely know exactly how much water to add by monitoring the water level through the transparent rotating water evacuation tube 110. The plant can then be irrigated and fed when necessary.

When watering the plant, users have the option of watering through the soil by pouring water onto the soil at the top of the base container 105 and letting water trickle down through the soil into the reservoir or pouring water directly into the reservoir via the feeding/watering/aeration tube 120 and allowing the water to wick up through the one or more wicking tubes 135. Feeding is easier and more efficient, because plant food can be dropped directly into the reservoir where it is dissolved into the water before it is extracted through the one or more wicking tubes 135. If overwatering accidentally occurs or after intentional soil saturation, water can be removed from the reservoir via the transparent rotating water evacuation tube 110 by simply rotating and allowing gravity to remove the excess water. This feature also prevents surface damage or messes caused by spillovers. From a conservation standpoint, water can be extracted from the reservoir via the transparent rotating water evacuation tube 110, and used to water another plant or re-water the host plant. A user can also easily observe when the water reserves have been depleted by visually monitoring the transparent rotating water evacuation tube 110. Better aeration takes place because both the transparent rotating water evacuation tube 110 and the feeding/watering/aeration tube 120 allow fresh, circulating air into the root area of the plant. The air mixes with the water before the water is absorbed into the plant via the one or more wicking tubes 135. Users now know when and how much to water the plant because watering is monitored in real time. Additionally, overwatering mistakes are easily corrected and there are no spills. The planter system, as described, prevents water damage to surfaces caused by spillovers.

When transplanting, a user simply grasps the handles 118 of the handled platform/transplanter insert 115 and lifts and removes the plant and platform from the base container 105 and places it on a surface outside of the base container 105. This process is less traumatic for the plant, easier for the user, more efficient, and less damaging to the container. The handled platform/transplanter insert 115 and platform legs 130 will support the plant in an upright position for inspection and maintenance before transplanting the plant into a new container.

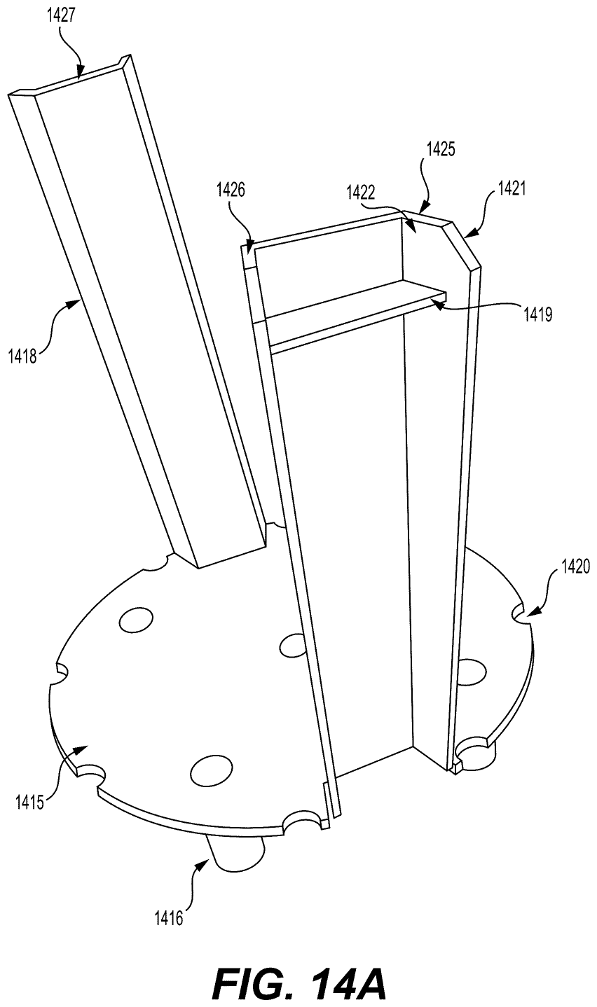

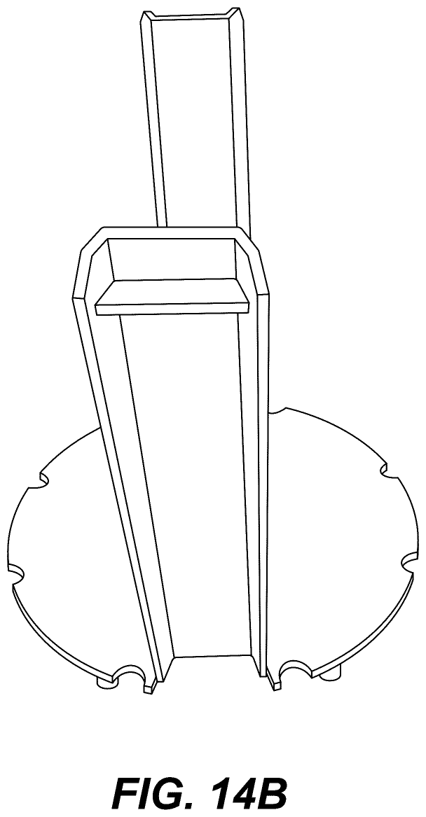

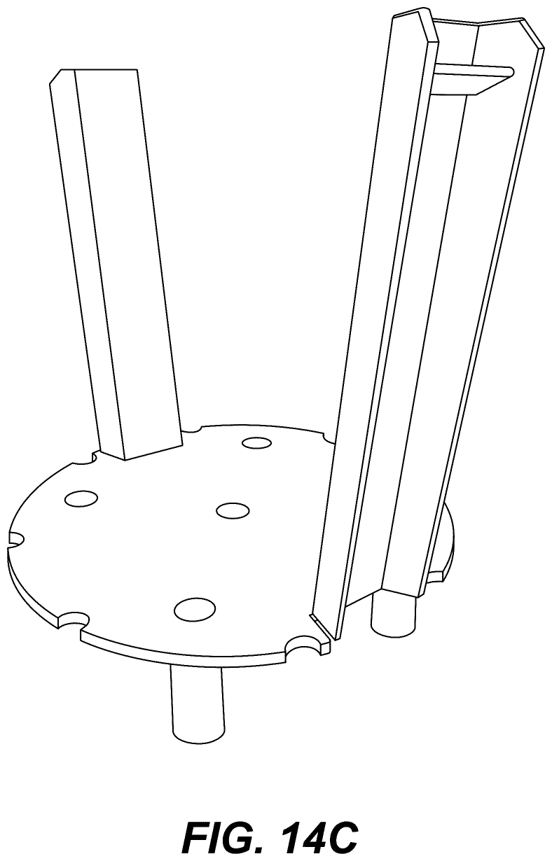

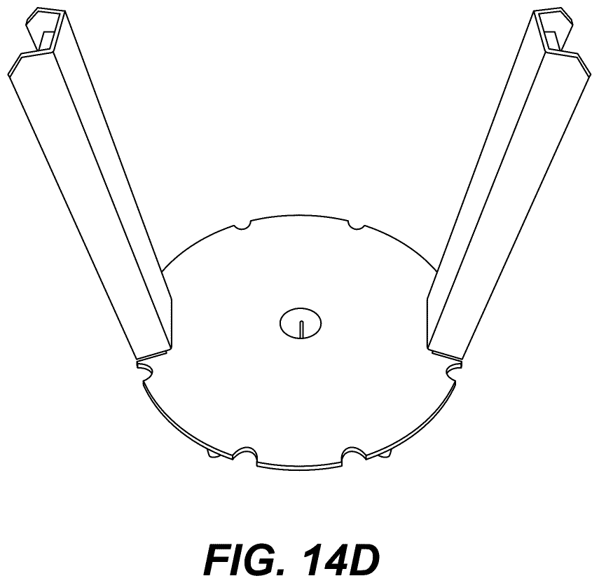

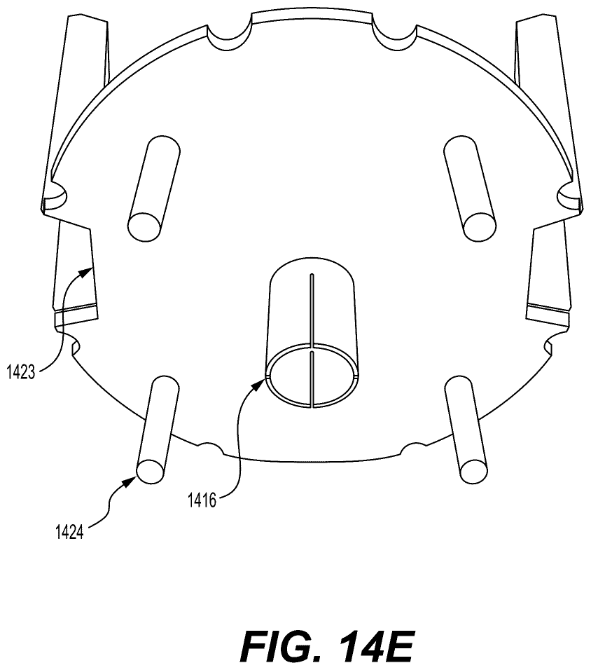

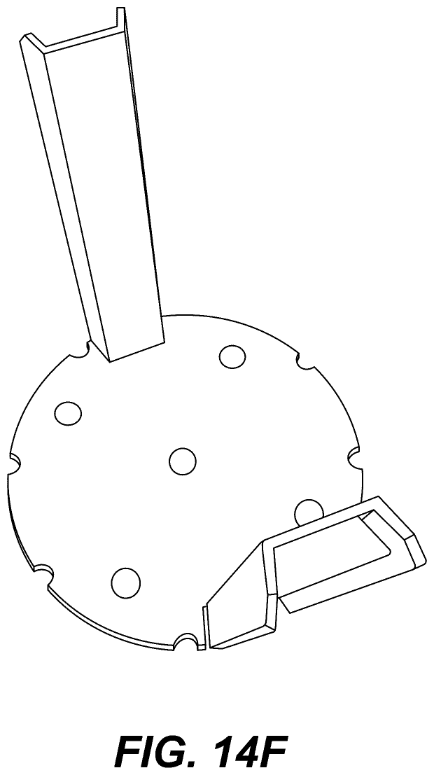

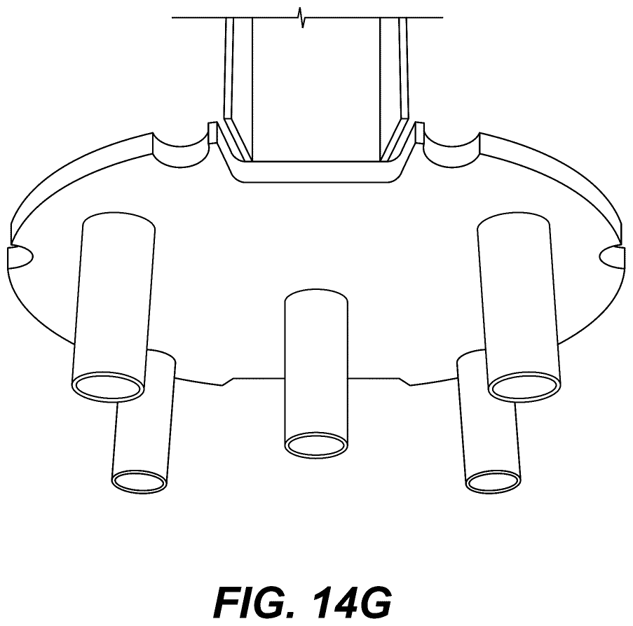

FIGS. 14A, 14F, AND 14G show a first alternative embodiment of a platform/transplanter insert 1415. Feeding/watering/aeration or “wicking” tube(s) 1416 extends through the handled platform/transplanter insert 1415 and through a hole at the bottom of the handled platform/transplanter insert 1415 into a base container. The number of wicking tubes 1416 not only control the rate at which water is absorbed into the soil but are also used to provide stability to the plant as it rests within the inner container. The handled platform/transplanter insert 1415 has handles 1418, 1422 that allows the handled platform/transplanter insert 1415 to be lifted making it easier to transplant a plant. In this embodiment, the handled platform/transplanter insert 1415 has five wicking tubes 1416 situated at the bottom of the handled platform/transplanter insert 1415 and this configuration of a cluster of wicking tubes would be desirable for plants requiring larger quantities of water.

FIGS. 14B, 14D, and 14E show a second alternative embodiment of a handled platform/transplanter insert 1415. The handled platform/transplanter insert 1415 can also include legs 1424 extending downward from the bottom portion of the handled platform/transplanter insert 1415 leaving space between the bottom portion of the handled platform/transplanter insert 1415 and the base container. Feeding/watering/aeration or “wicking” tube(s) 1416 extend(s) through the handled platform/transplanter insert 1415 and through a hole at the bottom of the handled platform/transplanter insert 1415 into a base container. However, the configuration in FIGS. 14B, 14D, and 14E has a sole wicking tube 1416 surrounded by a foursome of stability legs 1424. The number of wicking tubes 1416 not only control the rate at which water is absorbed into the soil but are while the stability legs are used to provide stability to the plant as it rests within the inner container. The handled platform/transplanter insert 1415 has handles 1418, 1422 that allows the handled platform/transplanter insert 1415 to be lifted making it easier to transplant a plant. In this embodiment, since the handled platform/transplanter insert 1415 has only a single wicking tube 1416 situated at the bottom of the handled platform/transplanter insert 1415 and this configuration of one wicking tube in the midst of a cluster of stability legs would be desirable for plants requiring smaller quantities of water.

The handled platform/transplanter insert 1415 can also include legs 1424 extending downward from the bottom portion of the handled platform/transplanter insert 1415 leaving space between the bottom portion of the handled platform/transplanter insert 1415 and the base container. Handles 1418, 1422 allow the platform/transplanter insert 1415 to be lifted making it easier to transplant a plant. The handled platform/transplanter insert 1415 allows the plant to sit on a flat surface after being removed from the base container. The handles 1418, 1422 of the handled platform/transplanter insert 1415 are designed to create a channel to let water and/or air flow to the bottom of the base container. The handles 1418, 1422 are also designed to funnel water into the channel when watering volume threatens to overflow the top area when pouring too quickly directly on the plant. After lifting and removing the handled platform/tranplanter insert 1415 from the base container, the platform handles 1418, 1422 fold out of the way. The platform/transplanter can have periodic openings 1420 around its perimeter that allows water to slowly seep into the lower regions of the base container. Base container has handles 1418, 1422 and component connection points 1423. The handles 1418, 1422 can be three sided, having two outer segments and a middle segment in the form of an incomplete isoceles trapezoid with the two outer segments corresponding to the non parallel legs 1425, 1426, and the middle segment corresponding to the shorter dimensioned parallel base 1427. The open side of the incomplete isoceles trapezoid corresponding to the of the longer dimensioned parallel base. The middle segment 1427 has the ability to bend while the two outer segments 1425, 1426 are shorter and do not fully extend due to the beveled edges 1421 to the top or bottom of the base container. Handles 1418, 1422, also have ledges 1419 that also extend out from the main segment 1427 such that the ledge is attached to the main segment and the two side segments 1425, 1426, but not past where the beveled edges start 1421. The presence of the ledge near the top part of the handles 1418 and 1422 (as shown) allows a user to easily grasp the handles 1418, 1422 of the handled platform/transplanter insert 1415 for removal without hindering water flow into the reservoir.

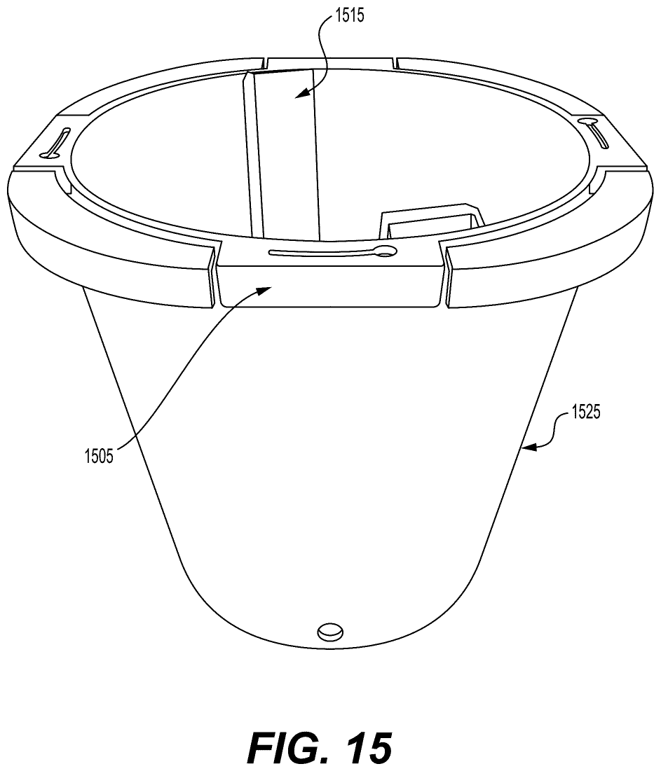

FIG. 15 is an illustration of a planter system having watering and aeration mechanisms. A base container 1505 includes an opening for transparent water evacuation tube located at a bottom portion of the base container. The transparent water evacuation tube is movable from a position pointing up holding water in the base container, and a position pointing down to drain water from the base container. Intermediate positions are also possible. It serves as a water level gauge, water level set, and water inlet/outlet. The base container also includes a through hole to accommodate the transparent water evacuation tube. The through hole, in some embodiments, is an elongated cylinder that adds stability and strength. FIG. 15 also depicts is an illustration of the outer container 1525 having an opening. Outer container handles interlock with base container handles which allows for easy alignment of the opening of the outer container 1525 and elongated hole tunnel of base container 1505.

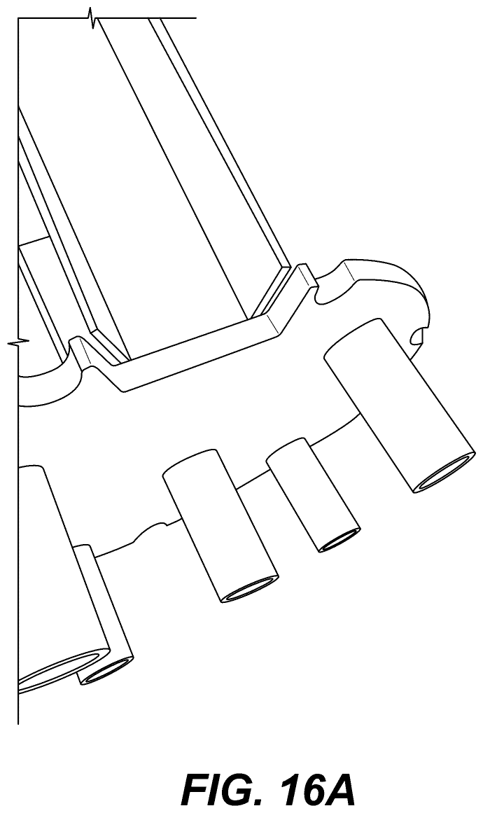

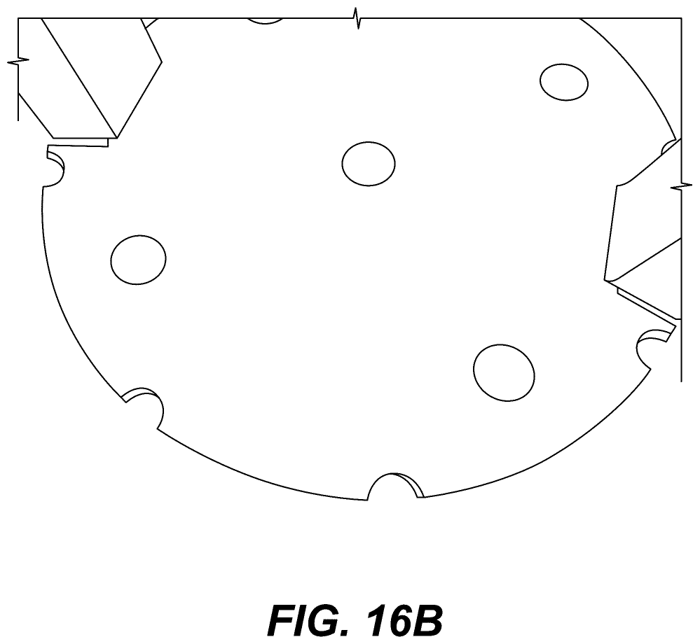

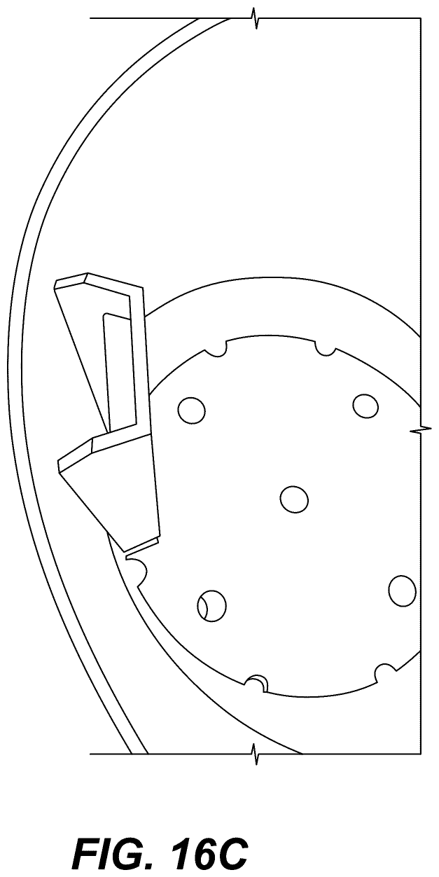

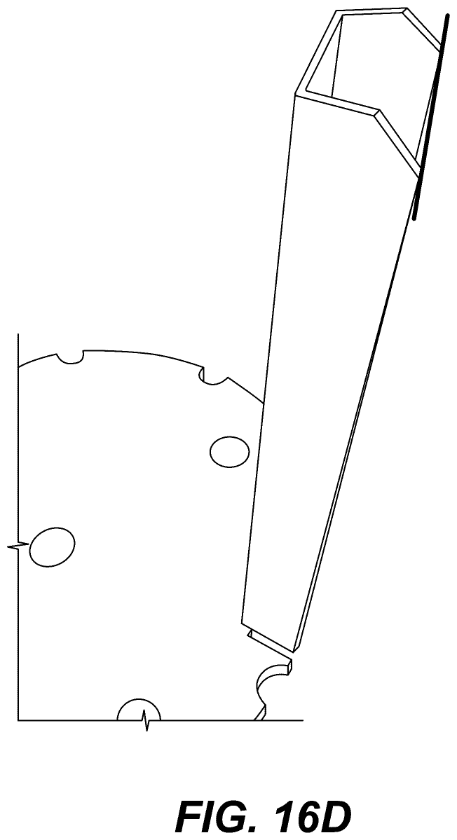

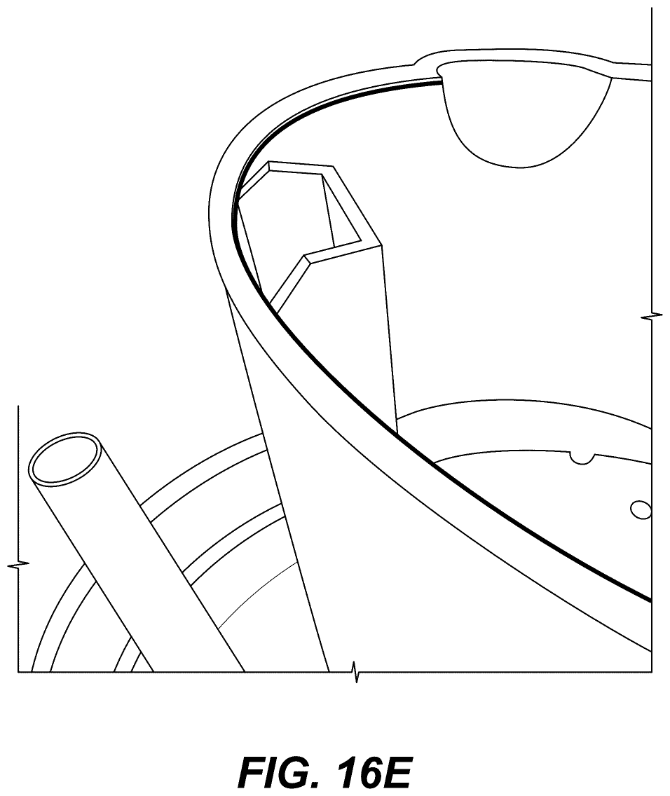

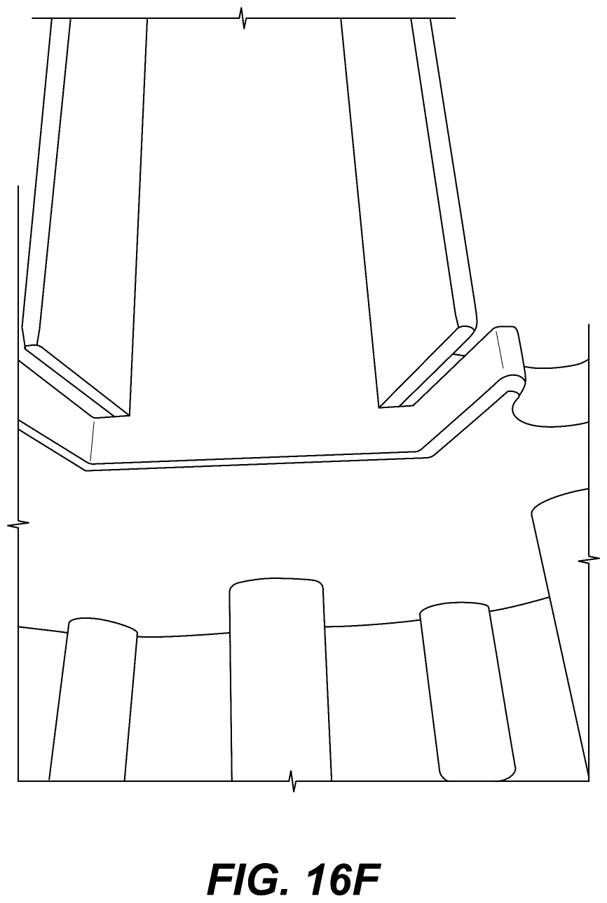

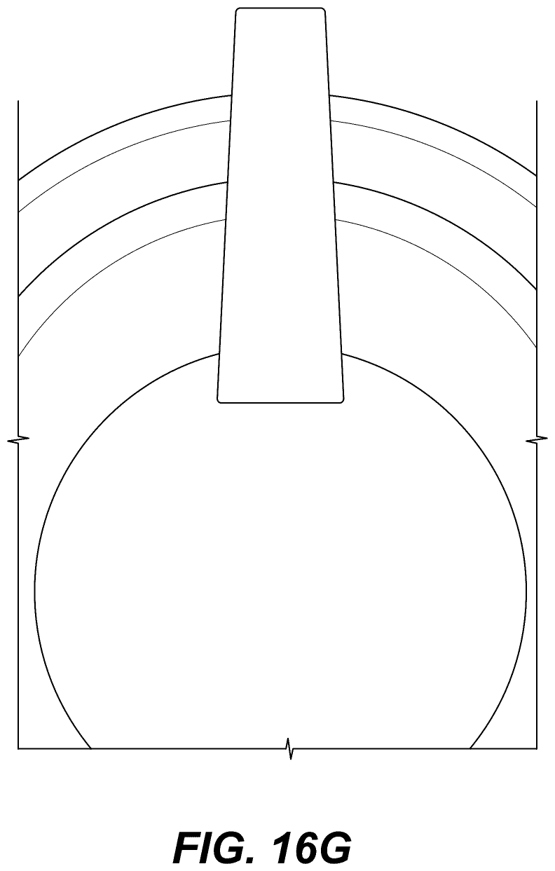

16A, 16B, 16C, 16D, 16E, 16F, and 16G are additional illustrations the handled platform/transplanter insert for use with the plant system including an alternative embodiment of the handles as discussed with regards to FIGS. 14A, 14B, 14C, 14D, 14E, 14F, and 14G. The handled platform/transplanter of FIG. 16B slides into the opening on the inner container of FIG. 15 And the handles fold 90° degrees away from the upright position after removal which allows total access to the plant and soil if necessary. As shown in FIGS. 16D & 16E the top rear of the handle is slanted when placed against the side of the inner container. This configuration allows for water to flow into the created channel when watering a plant from the top and prevents container overflows. As shown in FIG. 16C, the handle top is left open in order to allow ample space to pour water into the channel that leads to the reservoir. And as noted in FIG. 14A, the ledge 1419 allows the user to grip the platform when attempting to remove the platform from the inner container, but its presence does not impede water flow since it is not fully extended. FIGS. 16F and 16G depict the multi-side handle which creates a channel when placed inside the inner container. However, only the middle straight segment 1427 is attached to the handled platform/transplanter insert which allows the handle to bend. FIG. 20 shows an enlarged portion of FIG. 16E where the slanted recessed handle areas 2025, 2026, 2027, 2021 create a larger space A for watering and easier access for grasping the handled transplanter platform insert's ledge 2019 when attempting to remove the insert during transplanting.

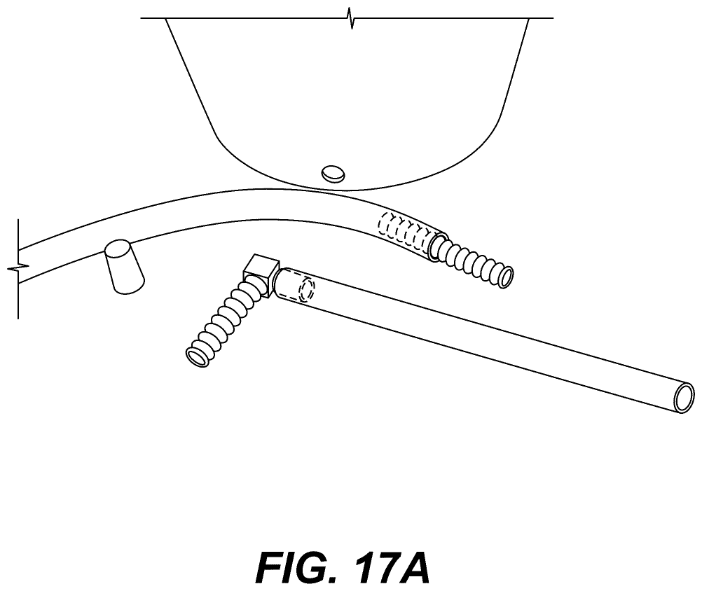

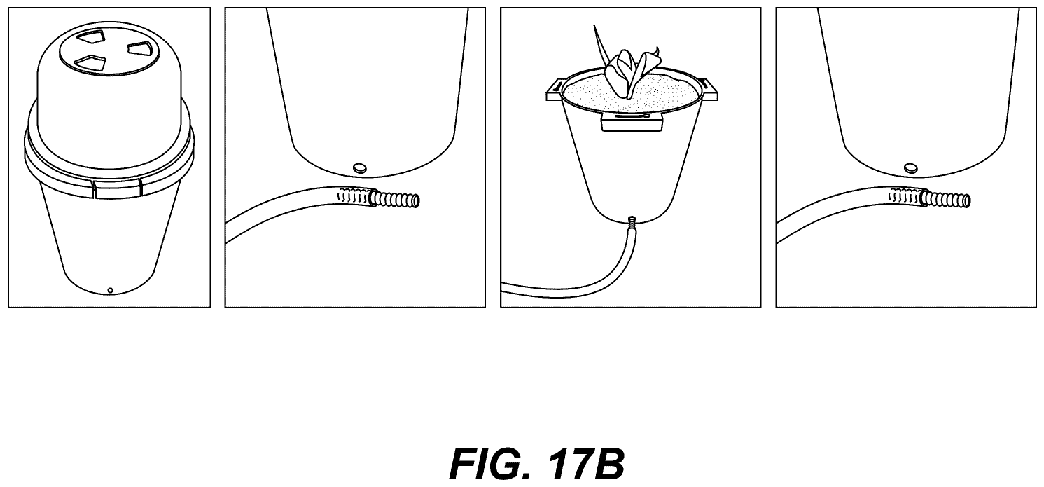

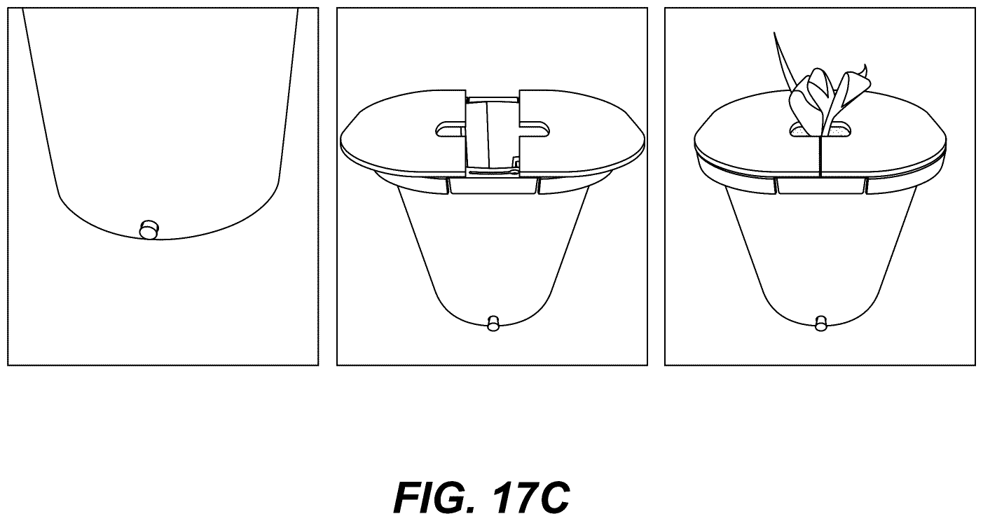

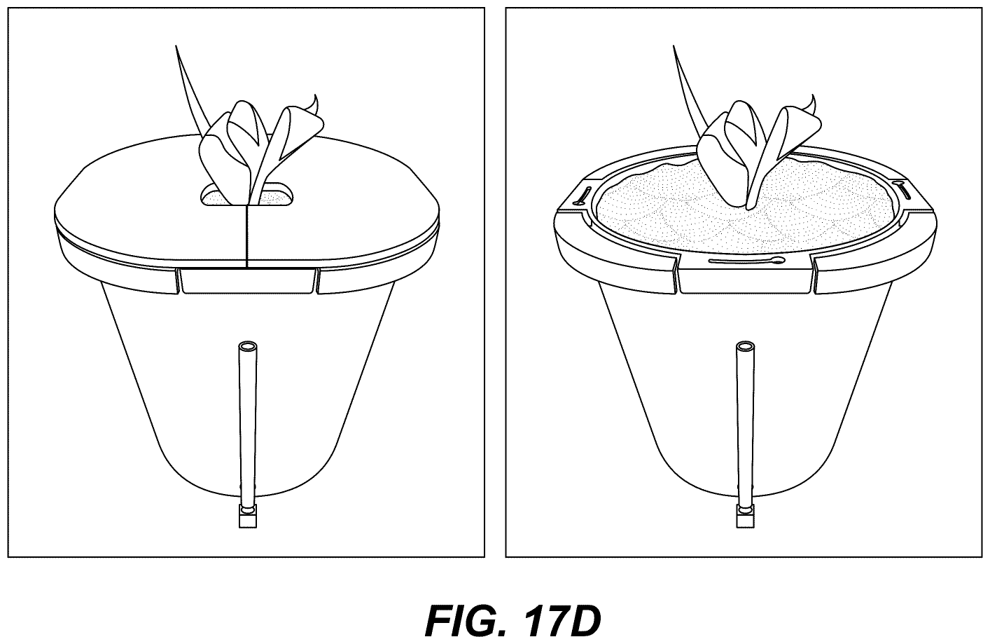

17A, 17B, 17C, 17D, 17E, are additional illustrations of the base container with a water access point that couples to either a hose, plug, or a spout. The attachment point changes the function of the system based upon the varying attachments as shown in FIG. 17A. FIG. 17B shows how a dome can be attached to the inner container rim along its attachment points 225 as shown in FIG. 2D for seed germination with a subsequent hose attachment for irrigation. The dome and hose can be removed when the plant is ready to be shipped. FIG. 17C shows an attachment of a plant skirt to the attachment points 225 of the to the inner container's top rim and the use of a plug for the water access point to prevent water leakage of a plant when in transit. FIG. 17D shows the replacement of the plug with a waterspout. FIG. 17E shows the incorporation of a wire support cage for a climbing plant where the wire support cage can attach to the handles of the base container at the attachment points 225.

From an aesthetic standpoint, the outer container 1525 of the planter system can be made of any material and have any design or color scheme. The containers are interchangeable which allows a plant to be presented in a new or different container easily and without any trauma. The plant and base container 1505 can be transferred to a different type, color, style, etc. of outer container 1525 to change the appearance, if desired. The potential design, material, and color schemes and/or themes are truly unlimited. Users can also forgo the outer container 1525 altogether and visually enjoy the natural beauty of the plant, soil, and developing plant root system in a transparent or opaque base container 1505. The base container 1505 fits snugly inside the outer container 1525. A handled platform/transplanter insert 1415 with legs 1515 and one or more wicking tubes fits snugly inside of the base container 1505 (space around sides let water flow through soil into bottom into the reservoir). A transparent rotating water evacuation tube is attached through a hole in the side near the bottom of the base container. The handled platform/transplanter 1415 has a feeding/watering/aeration tube 1416 attached to a hole in the handled platform/transplanter insert 1415.

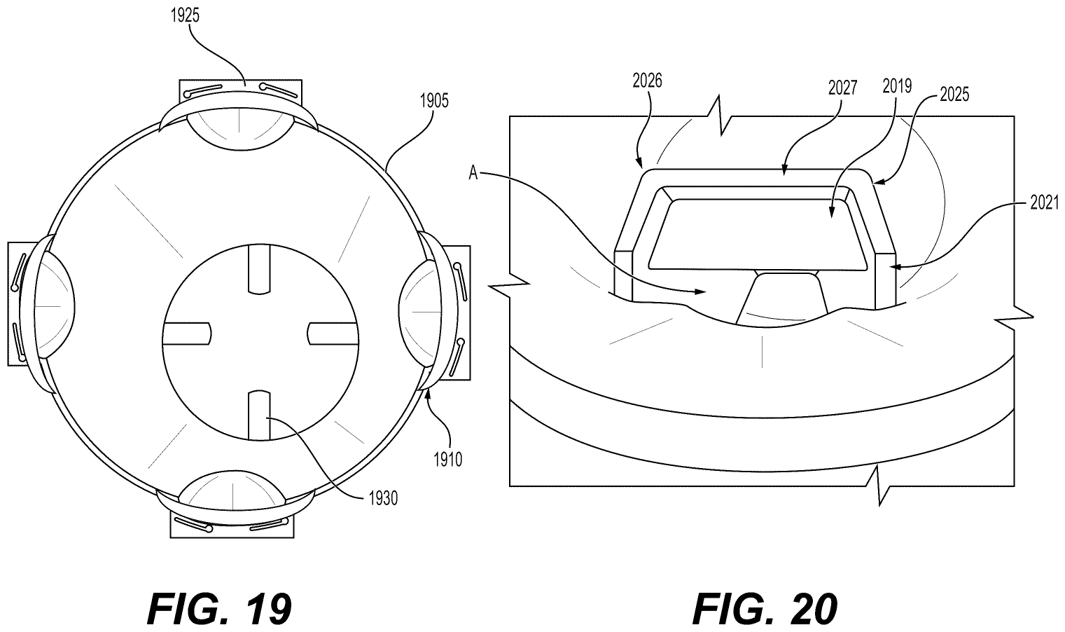

FIG. 19 is an alternative embodiment of the outer container of FIG. 2D. Here, the outer container 1905 has multiple openings (not shown) corresponding to the single opening 215 of FIG. 2D. Accordingly, a transparent water evacuation tube 110 slides into each opening of the outer container 1905 negating the need for slot 200 and gate 205, as illustrated in FIGS. 2A to 2C. Four outer container handles 1925 interlock with base container arcuate attachment points 1910 that accommodate the corresponding arcuate recessed areas of the outer container handles 1925 such that they achieve a secure snap-fit. This allows for easy alignment of the openings (not show) of the outer container 1905 and elongated hole tunnels 1930 of base container. The outer container 1925 of FIG. 19 may also be used as a nursery pot by removing the water evacuation tubes 110.

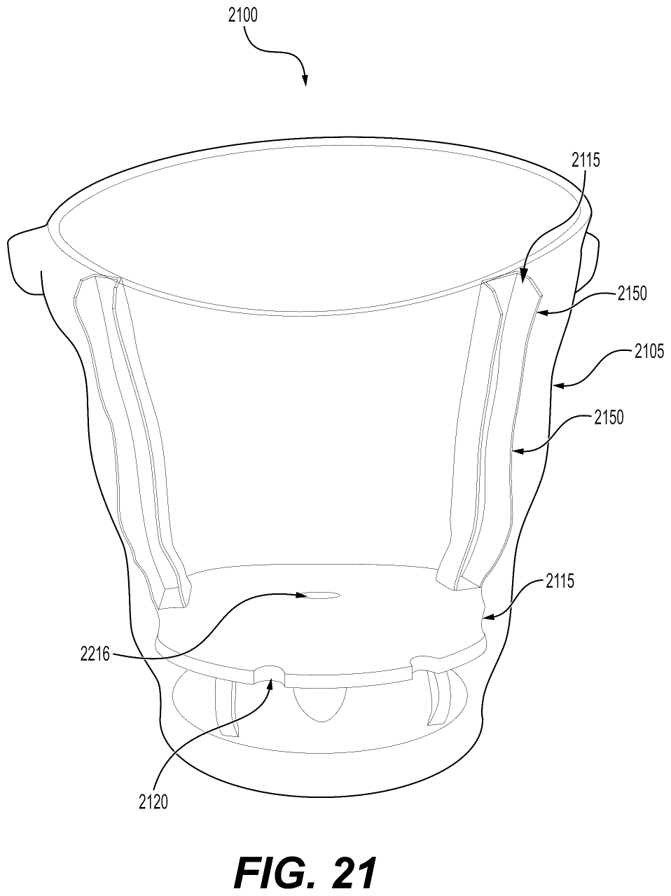

FIG. 21 discloses a handled platform/transplanter insert 2115 is located in the base container 2105. Feeding/watering/aeration or “wicking” tube(s) 2116 extend(s) through the handled platform/transplanter insert 2115 and through a hole at the bottom of the handled platform/transplanter insert 2115 into a base container 2105. The handled platform/transplanter insert 2115 has handles 2118 that allows the handled platform/transplanter insert 2115 to be lifted making it easier to transplant a plant. Here each handle has a point of undulation 2150 along the vertical length of each handle that allow excess water to drain from the root area into the bottom reservoir of the base container 2105. In this embodiment, the triangular support piece for each handle is eliminated and each handle is attached to the platform of the handled platform/transplanter insert 2115 at the middle segment of the handle 2118. This middle segment is parallel to the middle part of the handle 2118 and as such allows for the multisided part to bend at a 90 degree angle. The specialized handled insert of 2115 serves as a transplanter, a platform for plants upon which to rest, a ceiling for the water reservoir, a means of soil aeration, a means for spill abatement from the top, a wicking mechanism, and allows water to be added into the base container 2105.

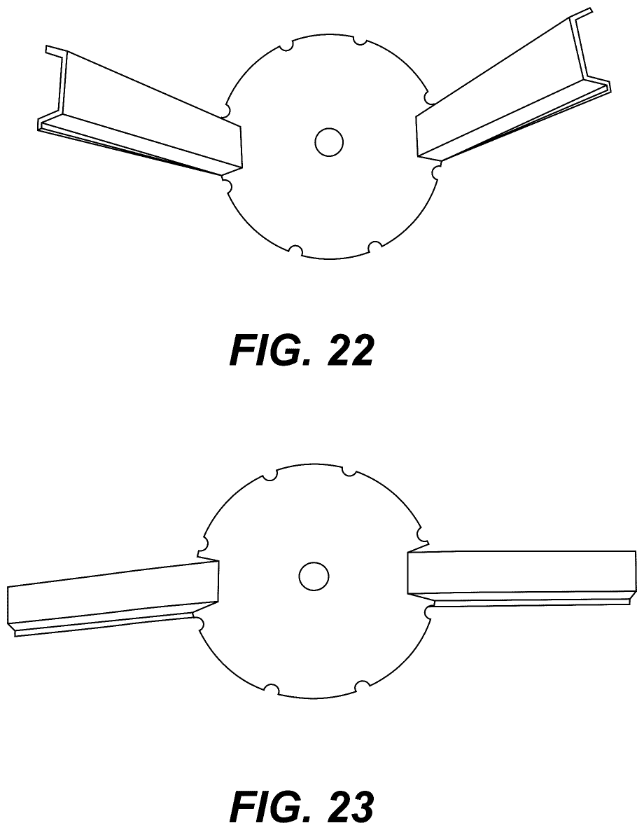

FIG. 22 shows a view of the handled platform/transplanter being removed from the base container of FIG. 21. FIG. 23 shows a view of the handled platform/transplanter being removed from the base container of FIG. 21 where the handles are 90 degrees away from the platform such that in this configuration total access to the soil and plant is obtained without obstruction. This configuration has the handles and platform of the handled platform/transplanter insert sharing a common horizontal plane such that multiple handled platform/transplant inserts can be stacked atop each other in a space saving arrangement when not in use.

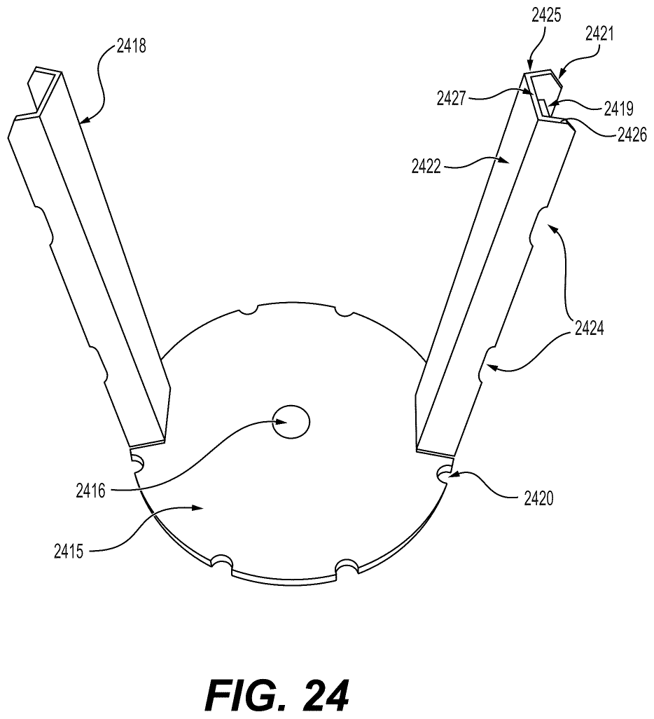

FIG. 24 show a first alternative embodiment of a handled platform/transplanter insert 1415. Feeding/watering/aeration or “wicking” tube 2416 extends through the handled platform/transplanter insert 2415 and through a hole at the bottom of the handled platform/transplanter insert 2415 into a base container. The number of wicking tubes 2416 not only control the rate at which water is absorbed into the soil but are also used to provide stability to the plant as it rests within the inner container. The handled platform/transplanter insert 2415 has handles 2418, 3422 that allows the handled platform/transplanter insert 2415 to be lifted making it easier to transplant a plant. In this embodiment, the platform/insert has one wicking tube 2416 situated at the bottom of the handled platform/transplanter insert 2415. Since the platform/insert has only a single wicking tube 2416 situated at the bottom of the handled platform/transplanter insert 2415 makes this configuration desirable for plants requiring smaller quantities of water. Handles 1418, 1422 allow the handled platform/transplanter insert 2415 to be lifted making it easier to transplant a plant. The handled platform/transplanter insert 2415 allows the plant to sit on a flat surface after being removed from the base container. The handles 2418, 2422 of the platform/transplanter insert 2415 are designed to create a channel to let water and/or air flow to the bottom of the base container. The handles 2418, 2422 are also designed to funnel water into the channel when watering volume threatens to overflow the top area when pouring too quickly directly on the plant. After lifting and removing the handled platform/tranplanter insert 2415 from the base container, the platform handles 2418, 2422 fold out of the way. The handled platform/transplanter can have periodic openings 1420 around its perimeter that allows water to slowly seep into the lower regions of the base container. The handles 2418, 2422 can be three sided, having two outer segments and a middle segment in the form of an incomplete isoceles trapezoid with the two outer segments corresponding to the non parallel legs 2425, 2426, and the middle segment corresponding to the shorter dimensioned parallel base 2427. The open side of the incomplete isoceles trapezoid corresponding to the of the longer dimensioned parallel base. The middle segment 2427 has the ability to bend while the two outer segments 2425, 2426 are shorter and do not fully extend due to the beveled edges 2421 to the top or bottom of the base container. A support 2417 ensures that the handles even though bendable have adequate stability while being attached to the handled platform/transplanter insert 2415. Handles 2418, 2422, also have ledges 2419 that also extend out from the main segment 2427 such that the ledge is attached to the main segment and the two side segments 2425, 2426, but not past where the beveled edges start 2421. The presence of the ledge near the top part of the handles 2418 and 2422 (as shown) allows a user to easily grasp the handles 2418, 2422 of the handled platform/transplanter insert 2415 for removal without hindering water flow into the reservoir. The side segments 2425, 2426 have serrated edges with serrations 2429 traversing the vertical length of each edge for each handle. These serrated edges allow air to percolate into the soil from the sides of the container which increases aeration while reducing soil compaction. The presence of these serrations 2429 does not interfere with the water flow into the reservoir.

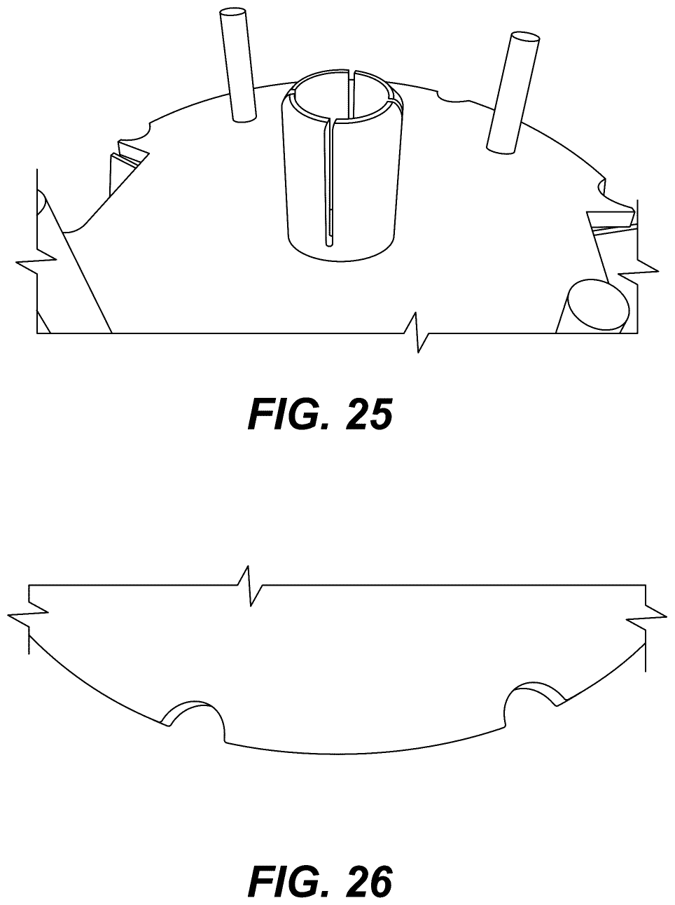

FIGS. 25 and 26 show aspects of the platform/transplanter insert concerned with how water is transferred throughout the structure. In FIG. 25, water can soak up into the soil that is packed into the wicking tube. The soaked soil then transfers the excess water into the soil above the platform. In FIG. 26, when watering from the top, the openings along the platform's edges allow excess water to seep down through the soil into the reservoir. The openings also allow air that enters from the handles and spout to enter into the soil from the bottom.

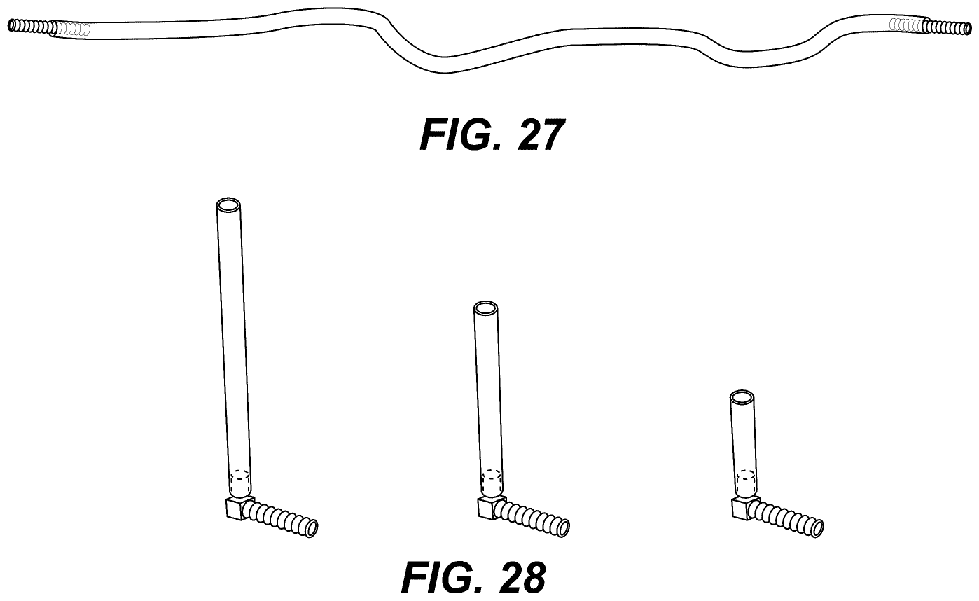

FIGS. 27 and 28 show various attachments that can be used in conjunction with the plant system such as the variable length hose of FIG. 27 or the spouts of varying heights of FIG. 28. The selection of any particular attachment would be based upon the specialized application desired.

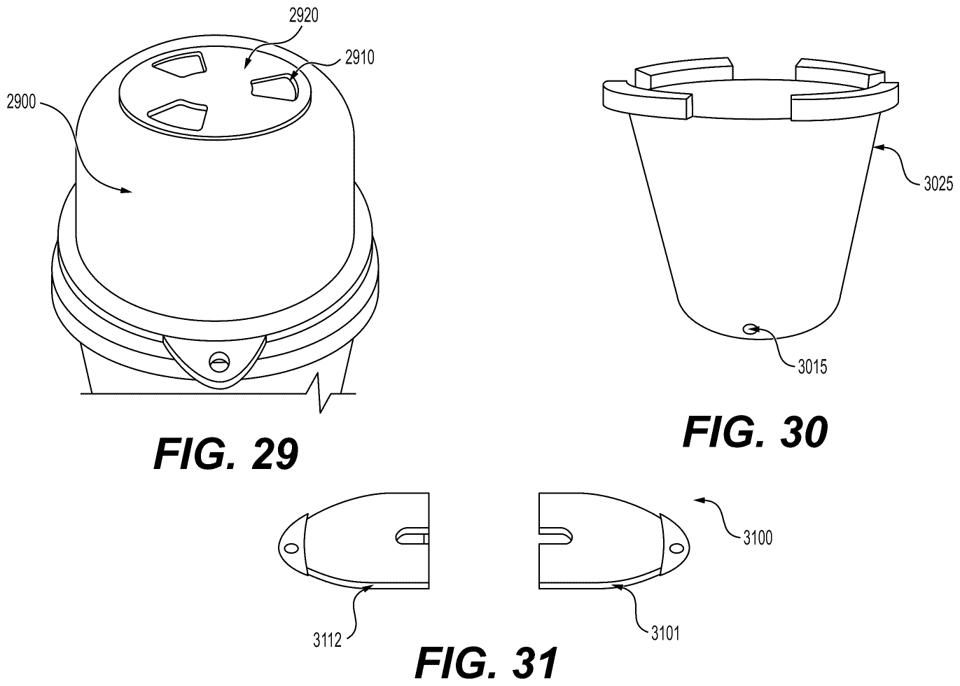

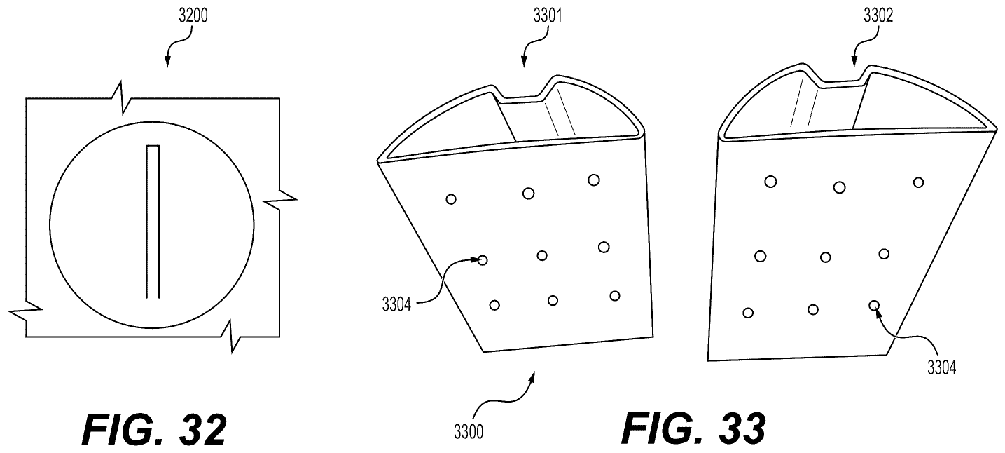

FIG. 29 shows a humidity dome, shipping dome or vermiculture dome 2900 for use with a decorative outer container 3025 of FIG. 30. The dome 2900 has a cover 2920 can be rotated open to provide three openings 2910 for the plant contained within the decorative outer cover when the dome is attached to said decorative outer cover. Rotating the cover 2920 clockwise opens up the three openings 2910. Rotating the cover counterclockwise closes the openings 2910. The dome 2900 has connection nodes that connect and lock onto the handle attachment points of the decorative outer container 3025 of FIG. 30. The dome 2900 can be used for germination and shipping purposes and the soil tended to without removing the cover by attaching one of the spouts or the variable length hose of FIGS. 27-28 to the opening 3015 in the decorative outer container 3025 of FIG. 30.

In lieu the dome 2900, a two piece interlocking plant protector 3100 as shown in FIG. 31 which when pieces 3101 and 3102 are interlocked and also attached to the decorative outer container 3025 of FIG. 30 can also secure the plant and soil within the decorative outer container 3025 while providing a small aperture in the middle of the plant protector 3100 for the plant to grow through. Or the decorative outer container 3025 can be shipped with both the plant protector 3100 of FIG. 31 attached first to the decorative outer container 3025 and the dome 2900 placed on top of the plant protector 3100 to where the plant protector 3100 would connect to two of the four connection points of the decorative outer container 3025 of FIG. 30, while the dome 2900 of FIG. 29 would connect to the remaining two connection points of the decorative outer container 3025 of FIG. 30.

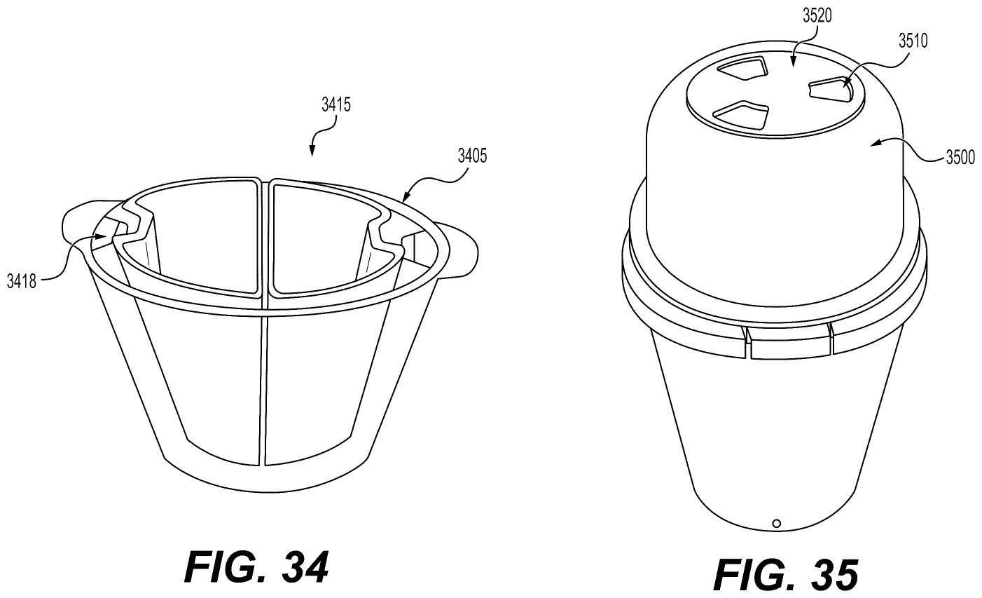

As shown in FIGS. 33-35, the handled platform/transplanter insert 3415 can also include two or more vermiculture containers (3301, 3302), as illustrated in FIG. 33, each having matching holes (3303, 3304) allowing worms to move back and forth. The vermiculture containers (3301, 3302) fit within the base container 3405 on top of the handled platform/transporter insert 3415 with the handles 3418 pushed to sides against the base container 3405. The vermiculture containers (3301, 3302) encourage horizontal migration and easier castings extraction. FIG. 34 is an illustration of the vermiculture containers (3301, 3302) located within the base container 340 on the handled platform/transplanter insert 3415. Handles 3418 are illustrated as protruding from the base container 3405 and can be used to easily transplant a plant from the base container 3405. A dome 3500, as illustrated in FIG. 35, can be connected to the vermiculture containers (3301, 3302) as they reside within base container 3405 and can help contain the worms and allow easy access for watering and feeding. The dome 3500 has a cover 3520 can be rotated open to provide three openings 3510 for compost contained within the decorative outer cover when the dome is attached to said decorative outer cover. Rotating the cover 3520 clockwise opens up the three openings 3520. Rotating the cover counterclockwise closes the openings 3510. The dome 3500 has connection nodes that connect and lock onto the handle attachment points of the decorative outer cover 3405 of FIG. 34.

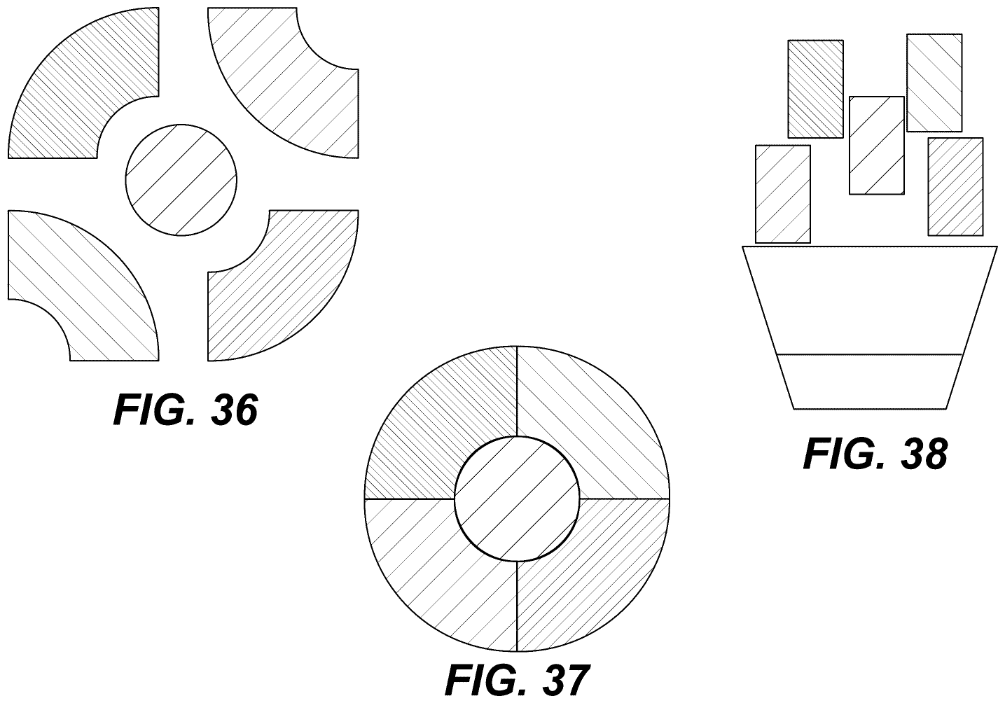

FIGS. 36-37 are a top view of multiple mini containers and FIG. 38 is a front view. Each of the mini containers vertically slides in and out individually and fits into the base container. They all rest on the handled platform/transplanter insert and fit around the platform handles. The tops of each of the mini containers are open but the sides are solid. The bottoms have numerous small openings to allow water to both enter and to drain from the container. The mini containers can be used to host a variety of plants like dish gardens or used as a plant nursery. This configuration is one example and many variations are possible. For example, matching holes can be included in the sides of the mini containers allowing worms to move back and forth; the mini containers can be transparent to allow visual inspection of the roots; or the mini containers can be of different sizes and shapes than those illustrated.

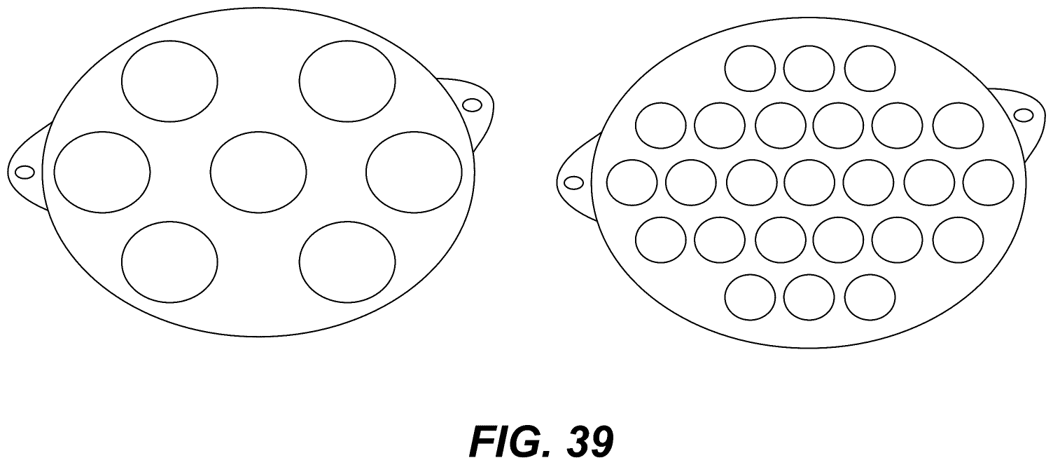

FIG. 39 is an illustration of two slotted inserts with multiple openings that hold open-ended breakaway containers. The open-ended breakaway containers hold immature plants until they are mature and ready for transplanting. The slotted inserts can include interconnections along the perimeter to interlock with the outer container handles or the base container handles. Alternately, the slotted inserts can include pegs along the perimeter, which fit into holes in the outer container handles or the base container handles.

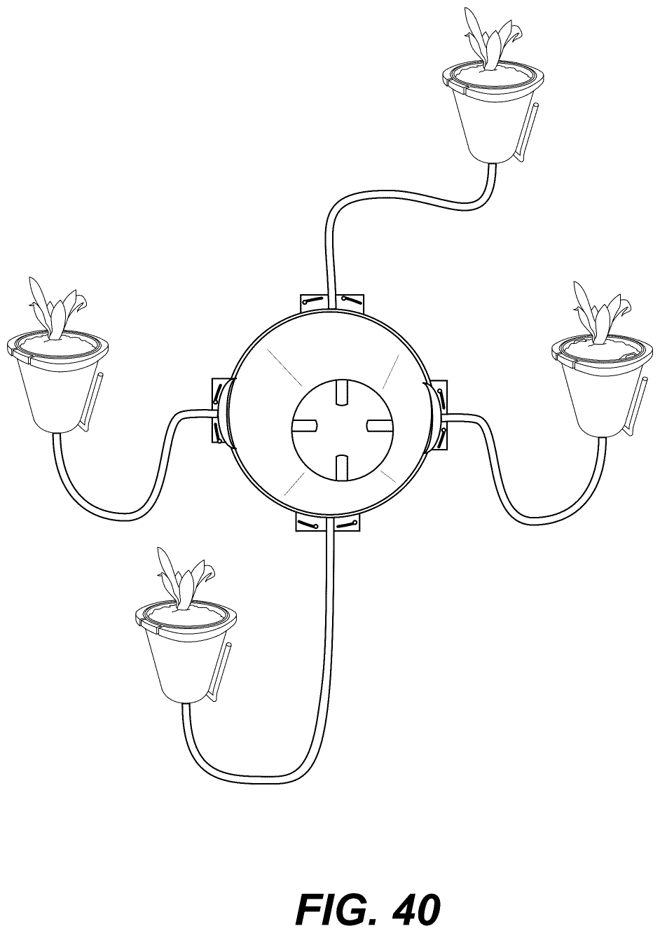

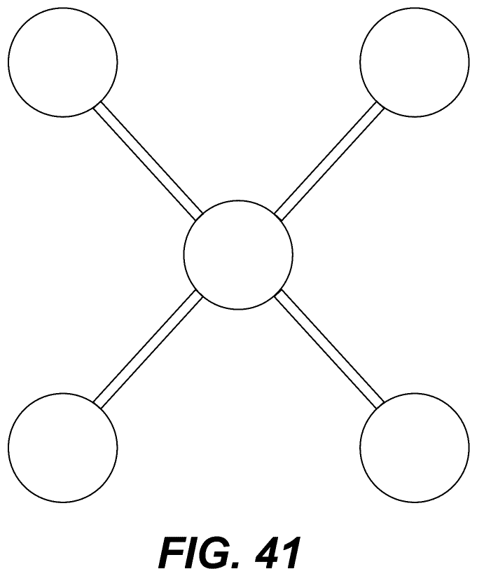

FIGS. 40-41 are illustrations of the use of the plant system of FIG. 19 as a central container or tank for having a source of water nearby for a plurality of plants. The centralized container is the source of water and is connected to each plant container by the plurality of elongated tubes terminating in a variable length hose of FIG. 27 between the central container and each plant container. Water will flow from the centralized container into the other connected plant containers through the hoses connected at each of the various connection points as discussed above. As a result, the water will equalize in all containers.

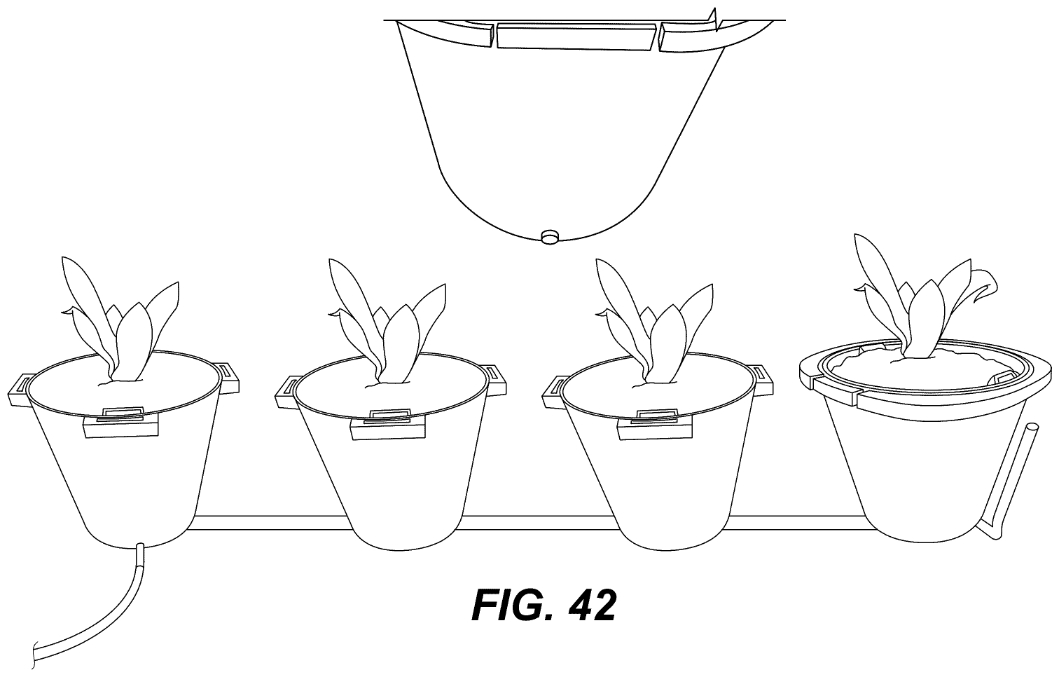

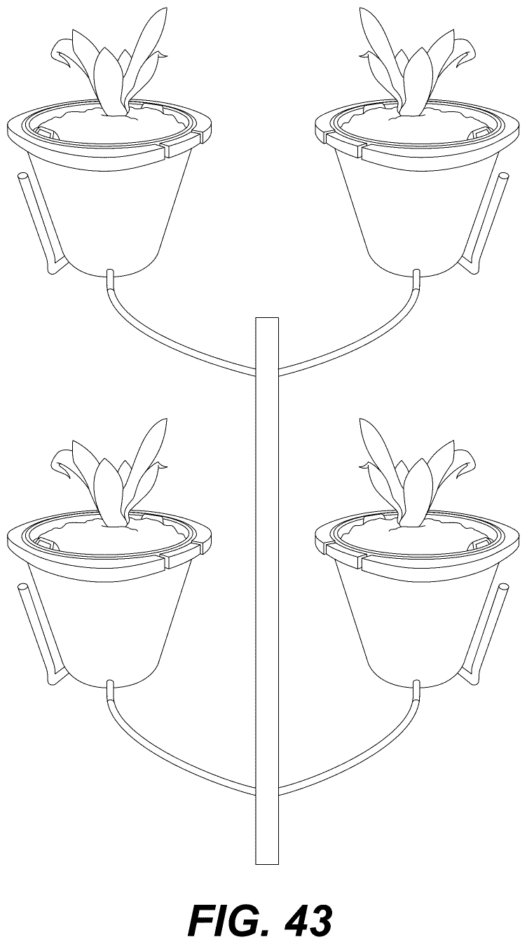

FIGS. 42-43 are illustrations of the use of a network of a plurality of base containers of plant system of FIG. 19 in providing water to many plants using a single source of water. FIG. 42 shows a series arrangement of a plurality of base containers of the plant system of FIG. 19 being connected on after another using the hoses of FIG. 27 and the spouts of FIG. 28. In FIG. 42, only one spout is shown at the very last base container the series arrangement. FIG. 43 shows a parallel arrangement of a plurality of base containers of the plant system of FIG. 19 being connected on after another using the hoses of FIG. 27 and the spouts of FIG. 28. In FIG. 42, only one spout is shown for every base container the parallel arrangement. The various attachment combinations can easily be modified to adapt the base containers functionality to a particular application.

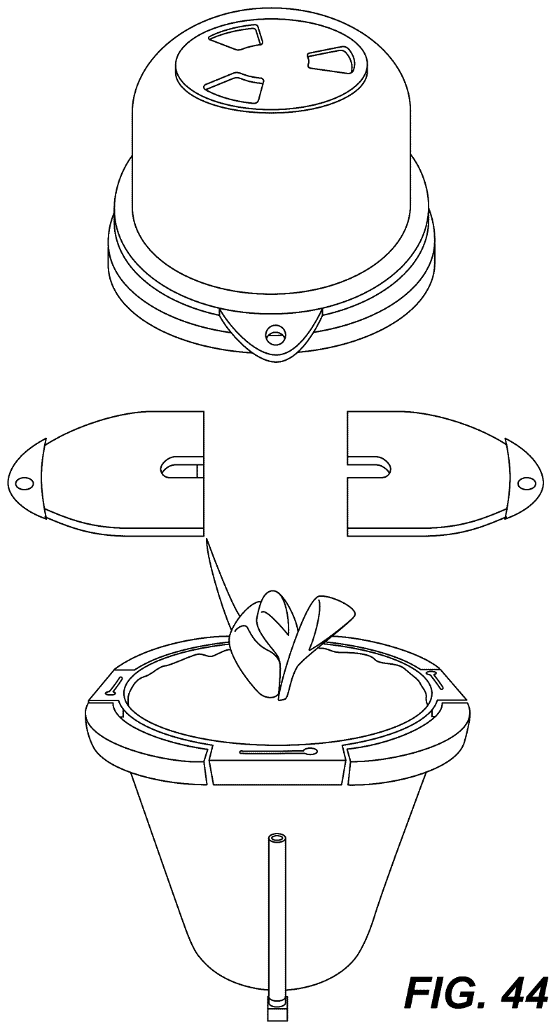

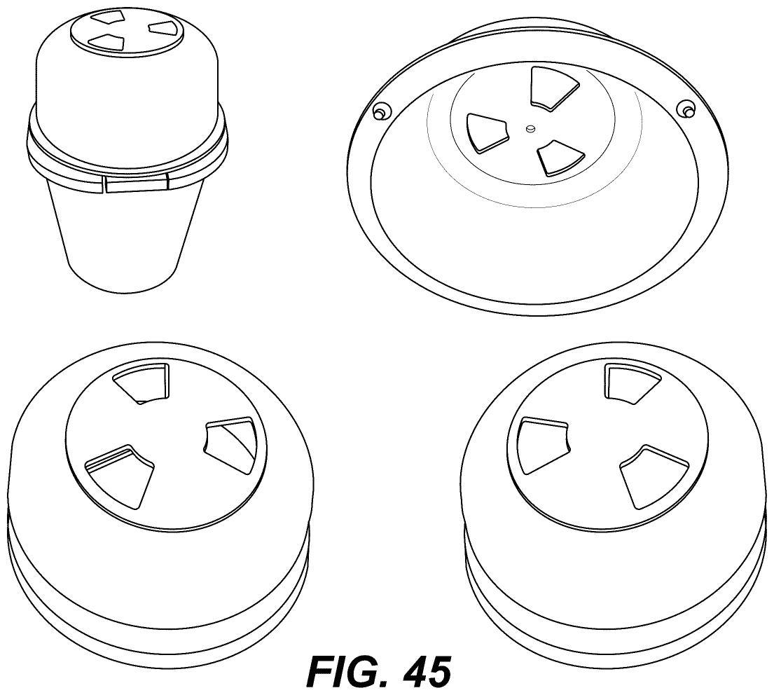

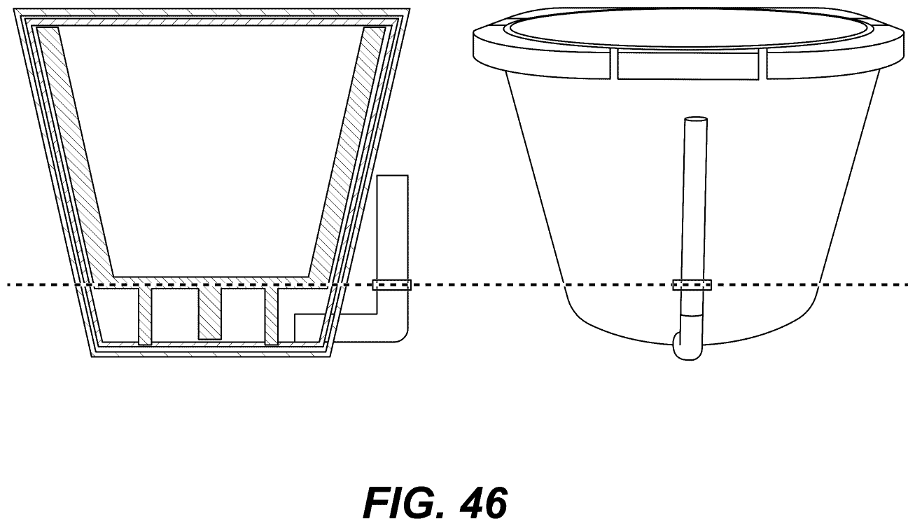

FIGS. 44-45 shows a humidity dome, shipping dome or vermiculture dome for use with a decorative outer container 3025 of FIG. 30. The dome has a cover that can be rotated open to provide three openings for the plant contained within the decorative outer cover when the dome is attached to said decorative outer cover. Rotating the cover clockwise opens up the three openings as shown in FIG. 45 (bottom leftmost depiction). Rotating the cover counterclockwise closes the openings as shown in FIG. 45 (bottom rightmost depiction). The dome has connection nodes as shown in FIG. 45 (top rightmost depiction) that connect and lock onto the handle attachment points of the decorative outer container 3025 of FIG. 30. The dome can be used for germination and shipping purposes and the soil tended to without removing the cover by attaching one of the spouts or the variable length hose of FIGS. 27-28 to the opening 3015 in the decorative outer container of FIG. 30.

As shown in FIG. 44, the two pieces of the plant protector are interlocked and also attached to the decorative outer container can also secure the plant and soil within the decorative outer container while providing a small aperture in the middle of the plant protector for the plant to grow through. Or the decorative outer container can be shipped with both the plant protector of FIG. 44 attached first to the decorative outer container and the dome placed on top of the plant protector 3100 to where the plant protector would connect to two of the four connection points as shown in FIG. 45 (top leftmost depiction) of the decorative outer container while the dome of FIG. 44 would connect to the remaining two connection points of the decorative outer container.

FIG. 46 shows an illustration of the rotating gauge/evacuation tube being marked/scored to match the level of the flat portion of the platform/transplanter insert. This feature allows the user to visual identify the perfect amount of water in the base container.

Currently, in typical container designs, the poured then stored water evaporates into the atmosphere without the plant absorbing the water. In addition, most users will not water their plants when there is water stored in the saucer which often causes the soil to become too dry, while waiting for the water to evaporate from the saucer. In the planter system, as described, the plants extract water from the reservoir via the one or more wicking tube 135. Additionally, less water is lost through evaporation because there is less exposed surface area from which water can evaporate.

A user, currently, cannot know when a container plant has become root bound because there is no way of knowing how well the root system has developed or if it is overgrown. The planter system, as described, allows user to remove the outer container and visually inspect the root system and overall health of the plant while the plant remains in the base container 105.

Transplanting plants using current systems is very traumatic for container plants and often shocks, stuns, and sometimes kills the plant during the process. The new planter system, as described herein, allows the plant to be gently removed from its current container without tugging on the plant. It is then moved to its new location without trauma or difficulty. When transplanting, a user simply grasps the handles 118 and lifts, then removes the plant from the base container 105. This process is less traumatic for the plant, easier for the user, and less damaging to the container.

From aesthetic and efficiency standpoints, container plants are routinely and traditionally placed in bland container/saucer pairings that are neither visually appealing nor efficient from a survival standpoint. The planter system, as described, allows for unlimited designs and materials to be used as presentation materials, and allows the host container's appearance to be easily changed. The outer container 125 of the planter system can be made of any material and have any design or color scheme. The potential design, material, and color schemes and/or themes are truly unlimited. The containers are also interchangeable, which allows a plant to be presented in a new or different container easily and without any trauma.

Below are issues associated with typical, conventional container plant care that are addressed and improved upon.

Current systems have inefficient water usage, because water often flows through the soil into or over the container saucers, and is never used by the plant, because of a high evaporation percentage or spillovers. Water is now stored in an enclosed reservoir, which lessens evaporation and eliminates spillovers.

The planter system, as disclosed, allows users to know when and how much water to use, because watering is monitored in real time. Overwatering damages or kills plants. The planter system, as disclosed, allows overwatering mistakes to be easily corrected, and there are no spills. Improper irrigation is eliminated.

Feeding is easier and more efficient because plant food can be dropped directly into the reservoir via the feeding/watering/aeration tube 120, where it is dissolved into the water, and is extracted by the plant through the one or more wicking tube 135.

A user can monitor root development through visual inspections of the root system; can easily check the overall health of plant; and know if and when the plant becomes root bound.

The planter system, as disclosed, allows plants to be saturated with water and then easily removes excess water.

A user can forgo the outer container 125 and use only a transparent base container 105 to visually enjoy the plant root system in addition to the plant itself. The base container 105 can be decorated/personalized as desired.

The planter system, as disclosed, prevents water damage to container host surfaces caused by overwatering spillovers. It also encourages strong root systems, because the plants seek water stored in the reservoir, instead of the roots lingering near the upper edge of plant containers. Better aeration takes place, because both the transparent rotating water evacuation tube 110 and the feeding/watering/aeration tube 120, allow fresh circulating air into the root area of the plant. The air mixes with the water before the water is absorbed into the plant via the one or more wicking tube 135.

It is to be understood that the planter system is not limited to the specific embodiments described above, but encompasses any and all embodiments within the scope of the generic language of the following claims enabled by the embodiments described herein, or otherwise shown in the drawings or described above in terms sufficient to enable one of ordinary skill in the art to make and use the claimed subject matter.

I claim:

1. A multifunctional planter system comprising,
a base container with upper and lower attachment points;
a platform/transplanter insert located in the base container;
foldable handles that extend upward from the platform/transplanter insert and rest against interior surface of the base container, wherein the handles are multi-segmented handles that form a channel for adding water to a reservoir of the base container;
and attachable multifunctional accessories,
wherein the handles are foldable by 90 degrees when the platform/transplant insert is removed from the base container.

2. The multifunctional planter system as recited in claim 1, wherein the lower attachment points are through holes allowing access to an interior of the base container in the form respective elongated tunnels, wherein the base container has one or more interior ports located at a bottom of base container and connected to said elongated tunnels, said one or more interior ports serving as accessory attachment points, wherein the respective elongated tunnels securely hold the attachable accessories of a rotating gauge, evacuation tube, cap, hose, spout, or other accessory and wherein said one or more interior ports are not serving as accessory attachment points, said elongated tunnels allow water to freely flow into or out of reservoir of the base container.

3. The multifunctional planter system as recited in claim 1, wherein the base container has upper attachment points that are built into the base container handles such that the base container handles assist with portability of planter system and properly aligning a decorative outer container with the base container.

4. The multifunctional planter system as recited in claim 1, wherein the handles are located near a top of the base container and are recessed to allow water to be poured into a plurality of channels behind the platform/transplanter insert.

5. The multifunctional planter system as recited in claim 1, wherein the base container has an engraved or raised mark or line providing a visual indication on an inside surface of the base container near a top of the base container where the engraved or raised mark or line aligns with a lower edge of the handled platform/transplant insert.

6. The multifunctional planter system as recited in claim 1, wherein the multi-segmented handles extend upward along the base container from the handled platform/transplanter insert, wherein the multi-segmented handles form a channel for adding water to the reservoir, and wherein the multi-segmented handles are serrated on their vertical edges which allows air to enter a plant's root system from sides of the multi-segmented handles for aeration purposes.

7. The multifunctional planter system as recited in claim 1, wherein the handles extend upward along the base container and wherein each handle has a ledge located near a top portion of each handle thereby creating accessible lifting points when a user is extracting the handled platform/transplanter insert along with a plant and soil resting on said handled platform/transplanter insert.

8. The multifunctional planter system as recited in claim 5, wherein the handles extend upward along the base container and wherein each handle has a slanted surface located near a top portion of each handle thereby directing water into the formed handle channels when excess water is poured into the base container, and wherein a lower rear portion of a slanted edge of the handles of the handled platform/transplanter insert aligns with the engraved or raised mark or line located on the inside surface near the top portion of the base container thereby reducing watering overflows by allowing excess water to flow to side walls of the base container above the engraved or raised mark or line by diverting the excess water away from the handles of the handled platform/transplanter insert such that the excess water subsequently flows over the slanted surface and into the created channel where the excess water is directed towards the reservoir.

9. The multifunctional planter system as recited in claim 1, wherein the handled platform/transplanter insert further comprises: legs extending downwards from a bottom portion of the handled platform/transplanter insert leaving space between the bottom portion of the handled platform/transplanter insert and the base container; and one or more wicking tubes extending into the base container creating a conduit for water to flow from the base container up through the handled platform/transplanter insert.

10. The multifunctional planter system as recited in claim 1, wherein the handled platform/transplanter insert has a solid platform with serrated edges, said serrated edges allowing excess water to seep into the reservoir when directly watering a plant, wherein said serrated edges also allow air to enter the plant's root area from below, and wherein the serrated edges allow the plants roots to extend into the reservoir.

11. The multifunctional planter system as recited in claim 9, wherein handled platform/transplanter insert has a platform with built-in legs, some of which are hollow, that extracts and transports water from the reservoir of the base container, wherein the one or more wicking tubes have small slits or openings in their sides to allow water to absorb into the soil before being wicked into a plants root system, wherein a subset of the legs function as wicking tubes while a remainder of the legs are solid such that they provide support and balance for the handled platform/transplanter insert after the handled platform/transplanter insert has been lifted and removed by a user from the base container and placed upon a flat surface.

12. The multifunctional planter system as recited in claim 1, wherein one of the attachable multifunctional accessories is a rotating gauge/evacuation tube/spout that is insertable into a lower attachment point of the base container, wherein said rotating gauge/evacuation tube/spout is movable from a position pointing upwards thereby retaining water in the base container to a position pointing downwards thereby draining water in the base container, wherein said rotating gauge/evacuation tube/spout is also moveable to a position intermediate said position pointing upwards and said position pointing downwards such that any excess water is expelled from the rotating gauge/evacuation tube/spout when said excess water rises above a predetermined rotating gauge/evacuation tube/spout height set by an angle of the rotating gauge/evacuation tube/spout with respect to the position pointing upwards, and wherein said rotating gauge/evacuation tube/spout has a mark that matches a level of the platform so that a visual indication of a water level in the reservoir is provided to a user when a decorative outer container is also being used with the base container and the handled platform/transplanter insert.

13. The multifunctional planter system as recited in claim 1, wherein the base container is colored or multi-colored, wherein a bottom portion of the base container located below a handled platform of the rotating gauge/evacuation tube/spout of the handled platform/transplanter insert is an overflow tray/reservoir, and wherein one attachable multifunctional accessory is a rotating gauge/evacuation tube/spout which when attached the lower attachment point provides a visual indication of an amount of water in the reservoir.

14. The multifunctional planter system as recited in claim 1, wherein the base container is transparent and the handled platform/transplanter insert is colored or multi-colored such that when the handled platform/transplanter insert is placed within the base container, the handled platform/transplanter insert remains the visible to a user.

15. The multifunctional planter system as recited in claim 1, wherein the base container has a two toned configuration including being colored or multi-colored from a top portion of the base container to a handled platform of the handled platform/transplanter insert and being transparent from the handled platform of the handled platform/transplanter insert to a bottom portion of the base container, and wherein in this two toned configuration the transparent bottom portion of the base container is used an overflow tray that provides a user with a visual indication of an amount of water in the reservoir.

16. The multifunctional planter system as recited in claim 1, wherein the base container nests and interlocks within an outer container, said outer container also having handles, such that the handles of the base container and the handles of the outer container respectively align with each other allowing an interlocking of the base container within the outer container and allowing access to the lower attachment points of the base container when nested within the outer container.

17. The multifunctional planter system as recited claim 1, where the base container securely attaches to an accessory attachment dome, said dome being used to cover the handled platform/transplanter insert and being attached to handles of the base container at the upper attachment points, wherein said accessory attachment dome is opaque when the base container is configured for composting with worms, wherein said accessory attachment dome is transparent when said base container is used for plant germination or as a terrarium cover, and wherein said accessory attachment dome has a plurality of openings on a top portion o said accessory attachment dome, said openings being fully open, fully closed, or partially open.

18. The multifunctional planter system as recited in claim 1, wherein the handled platform/transplanter insert houses a plurality of vermiculture containers each of said plurality of vermiculture containers having matching holes configured to allow worms to move back and forth between the plurality of vermiculture containers, wherein the plurality of the vermiculture containers rest upon the handled platform/transplanter insert and has a snug fit around the channels created by the handles, and wherein an accessory attachment dome fits over the plurality of vermiculture containers when said plurality of vermiculture containers abuts said base container handles.

19. The multifunctional planter system as recited in claim 1, wherein the handled platform/transplanter insert houses a plurality of miniature containers each of said plurality of miniature containers having holes on a bottom portion of each miniature container said holes allowing water to enter and drain, wherein said plurality of miniature containers rest upon the handled platform/transplanter insert and has a snug fit around the channels created by the handles, wherein an accessory attachment dome fits over the plurality of miniature containers when said plurality of miniature containers abuts said base container handles, and wherein the accessory attachment dome is removed by a user after plant germination as plants continue to grow.

20. The multifunctional planter system as recited in claim 1, wherein one of the attachable multifunctional accessories is a hydroponic rack with multiple slots that insertable to a top portion of the base container by being attachable the upper attachment points of the base container, wherein an individual plant container is placed in each of the multiple slots, and wherein a water level of the base container is raised using a rotating gauge/evacuation tube/spout or a plug/cap attachable accessory such that the root areas of each of the individual plant containers are submerged by water.

21. The multifunctional planter system as recited in claim 1, wherein one of the attachable multifunctional accessories is a hydroponic rack with multiple slots that insertable to a top portion of the base container by being attachable the upper attachment points of the base container, wherein an individual plant is placed in each of the multiple slots, and wherein a water level of the base container is raised using a rotating gauge/evacuation tube/spout or a plug/cap attachable accessory such that the root areas of each of the individual plant are submerged by water, and wherein the base container is transparent such that the root areas of each individual plant are viewable by a user.

22. The multifunctional planter system as recited in claim 1, wherein the base container securely attaches to a plant protector/shipping top said plant protector/shipping top being used to cover the handled platform/transplanter insert and being attached to the handles of the base container at a first set of upper attachment points, wherein said plant protector/shipping top fits around a stalk of a plant after filling the reservoir with water, wherein said plant protector/shipping top prevents the water and soil from spilling during a shipping process, wherein the plant protector/shipping top locks into place using port connectors, wherein an accessory attachment dome attaches to the base container over the plant protector/shipping top at a second set of upper attachment points, and wherein plug/cap attachable multifunctional accessories are attached to the lower attachment points of the base container to seal in water during the shipping process.

23. The multifunctional planter system as recited in claim 1, wherein one of the attachable multifunctional accessories is a hose which connects to the base container at one of the lower attachment points.

24. The multifunctional planter system as recited in claim 1, wherein one of the attachable multifunctional accessories is a recessed screw plug/seal which creates a waterproof seal after being inserted into the lower attachment point and rotated so smooth and flush fit is obtained by a user, and wherein the recessed screw plug/seal can be a different color from a color of the base container.

25. The multifunctional planter system as recited in claim 1, wherein the base container is a centralized based container that is connected to a plurality of base containers forming a network of base containers, wherein the centralized base container is empty and each of the plurality of base containers contain plants, wherein the each of the plurality of base containers is connected to the centralized base container by accessory hose attachments connecting the lower attachment points of the centralized base container to the at least one of the lower attachment points of each of the plurality base containers containing plants, wherein when water is added to the centralized base container the water will flow and be distributed to each of the plurality of base containers containing plants through the connecting accessory hose attachments such that water will equalize to a same level in the centralized base container and the plurality of base containers containing plants, wherein a rotating gauge/evacuation tube/spout is connected to at least one of the lower attachment points of one of the base containers containing plants in order to provide a visual indication of excess water within the planter system to a user, and wherein the base container having the at least one of the lower attachment points connected to the a rotating gauge/evacuation tube/spout controls an amount of water that remains in the network of base containers.

26. The multifunctional planter system as recited in claim 25, wherein the plurality of base containers containing plants are linked in a series configuration using accessory hose attachments attached at the lower attachments of the plurality of base containers.

27. The multifunctional planter system as recited in claim 25, wherein the plurality of base containers containing plants are linked in a parallel configuration using accessory hose attachments attached at the lower attachments of the plurality of base containers.

28. The multifunctional planter system of claim 1, wherein a plant cage is attached to the upper attachment points of the base container, said plant cage providing support for plants requiring support or growing space for plants having running vines.

29. The multifunctional planter system of claim 1, wherein a plurality of hanging plant supports are attached to the upper attachment points of the base container.
